(19) United States
(12) Patent Application Publication
(10) Pub. No.: US 2007/0175992 A1
(43) Pub. Date: Aug. 2, 2007

(54) INVENTORY AND POINT OF SALE MANAGEMENT SYSTEM

(76) Inventor: Michael James Brown, Los Angeles, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/626,142

(22) Filed: Jan. 23, 2007

Related U.S. Application Data
(60) Provisional application No. 60/761,504, filed on Jan. 23, 2006.

(51) Int. Cl. G06Q 30/00

(52) U.S. Cl. 235/385

(57) ABSTRACT

A computerized system including an integrated inventory and point of sale management system.

### BACKGROUND OF THE INVENTION

The subject invention relates generally to integrated inventory and point of sale management systems. Most small business do not have an inventory, labor, or point-of-sale system. Setting up inventory and point-of-sale systems that meet a merchant's needs requires much work. First, the merchant must locate a system that suits his particular business' requirements. The merchant must acquire specialized computer hardware and have it configured. The merchant must elicit the services of technical personnel capable of maintaining the system. If the merchant desires to also sell items on a web site, he must develop a web site and constantly maintain the items for sale thereon. The website typically does not communicate with any system in the physical retail store to let the system in the retail store know when an item has been sold on the website.

There is a need, therefore, for an integrated inventory and point of sale management system that manages a merchant's complete inventory, whether that inventory is sold on a website or in a retail store, and that can be managed through the use of an ordinary web browser. Text

### SUMMARY OF THE INVENTION

The present invention is directed to a computerized system including an inventory system and a point of sale system, the inventory and point of sale system being integrated.

### BRIEF DESCRIPTION OF THE DRAWINGS

FIGS. 1-62 depict screen shots of the computerized management system.

### DETAILED DESCRIPTION OF THE PREFERRED EMBODIMENTS

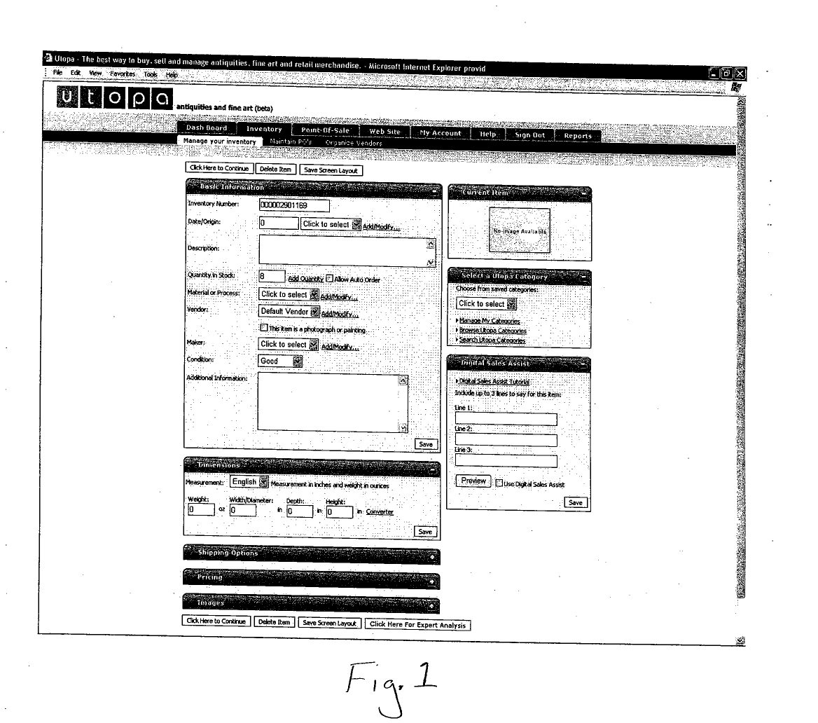

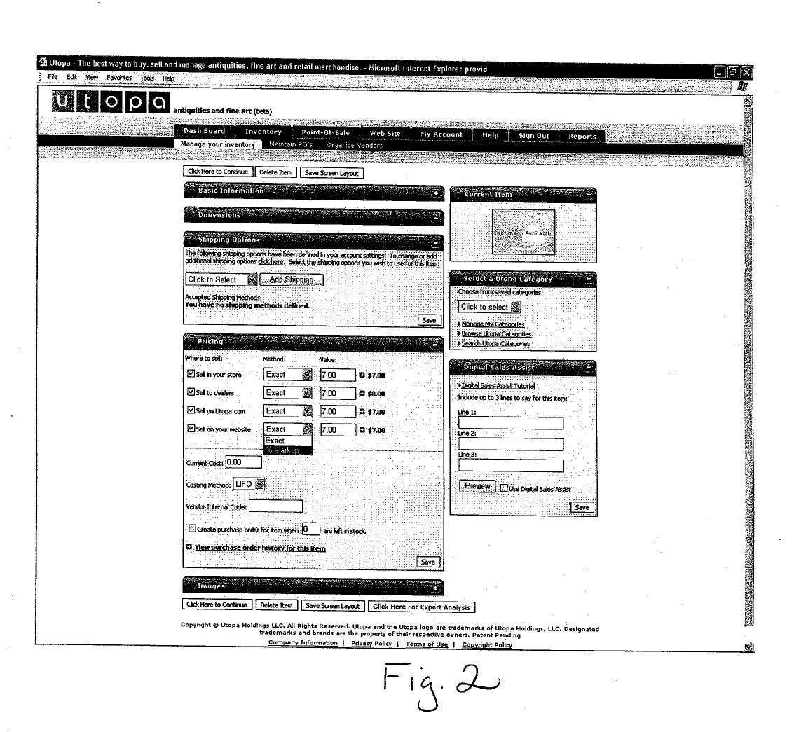

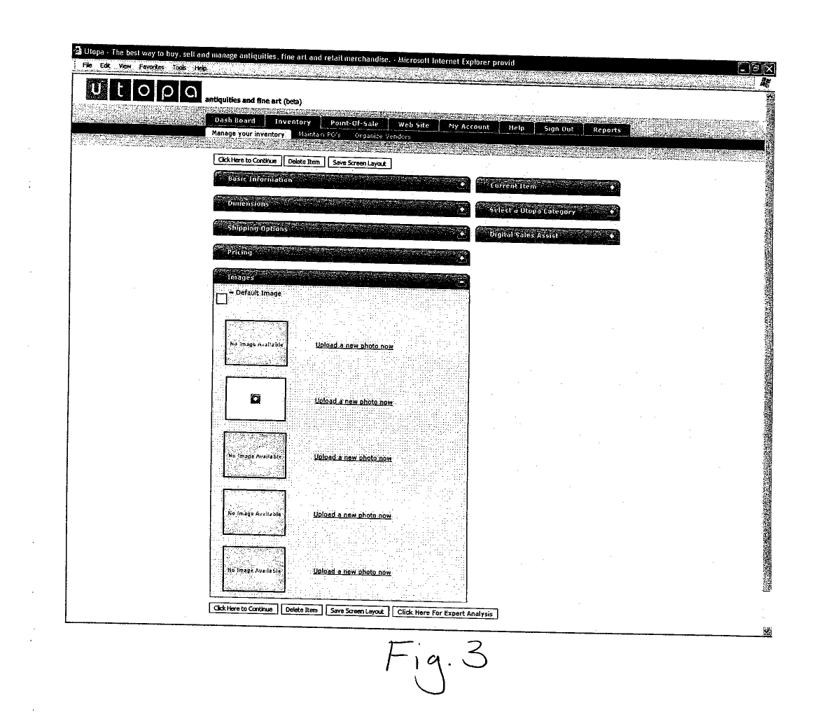

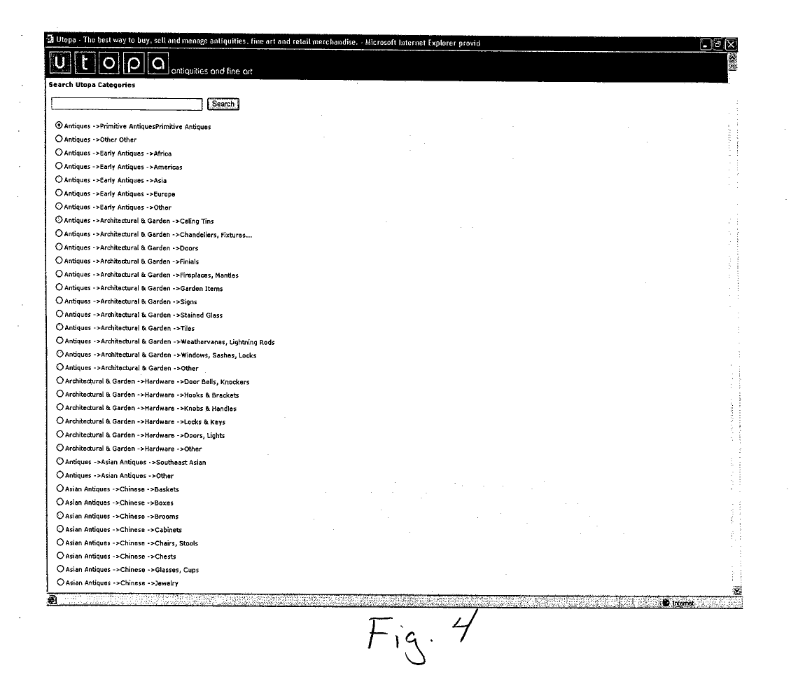

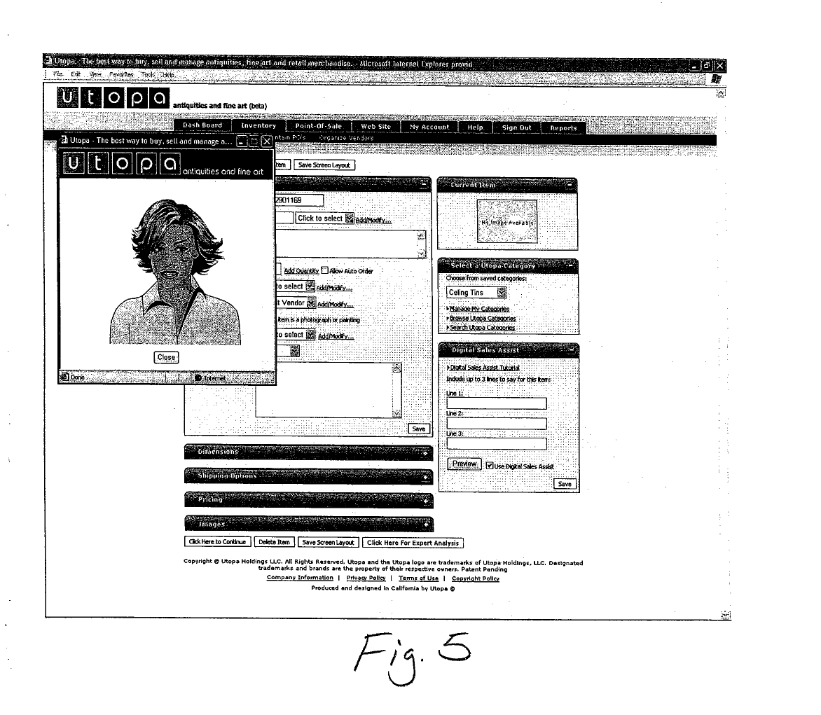

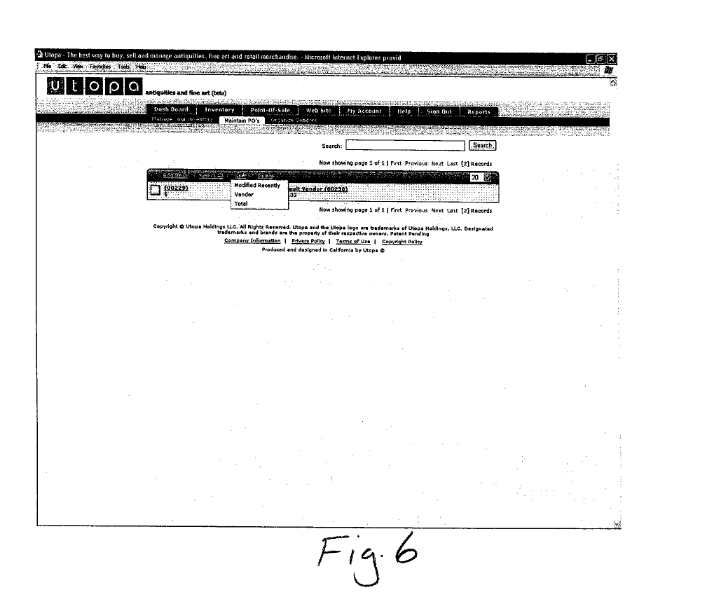

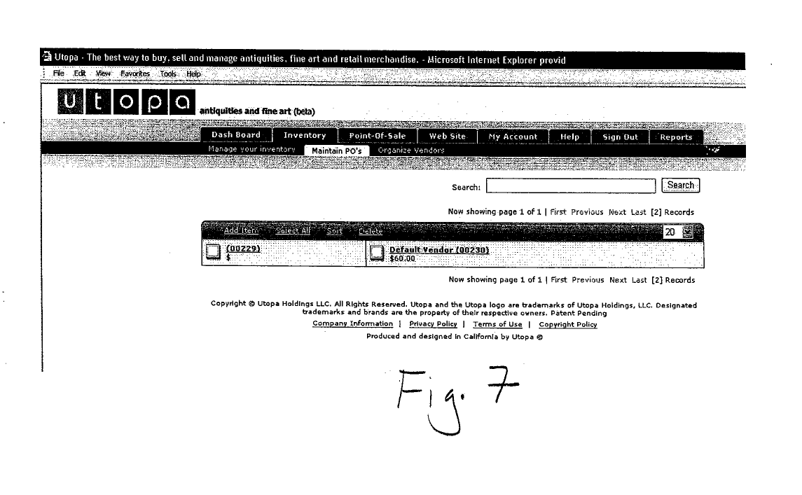

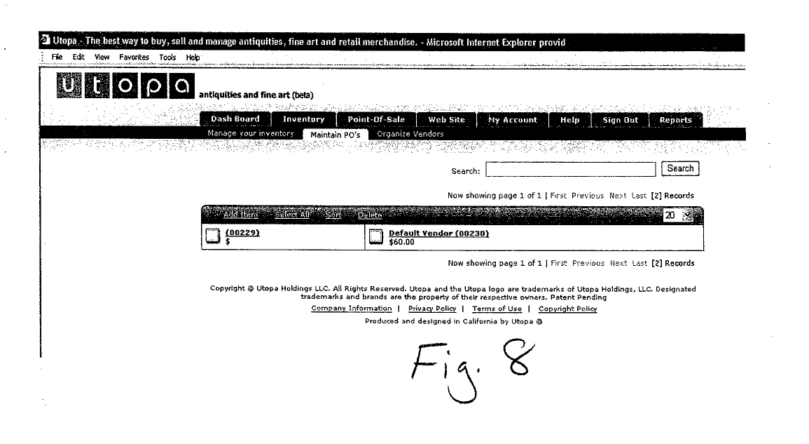

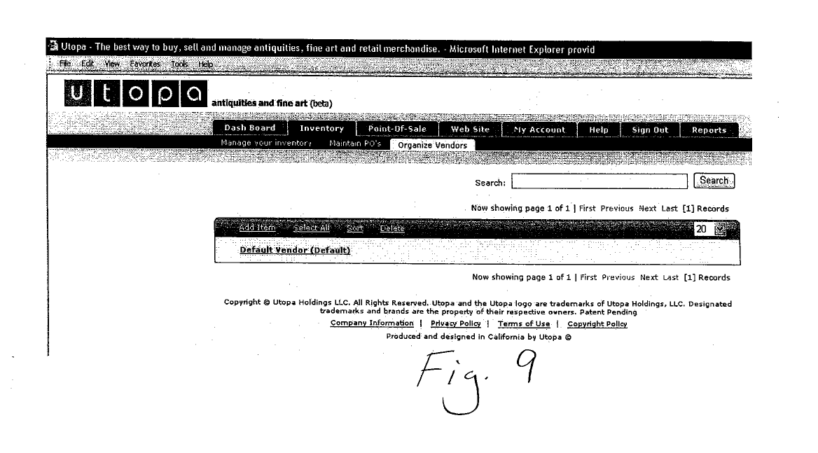

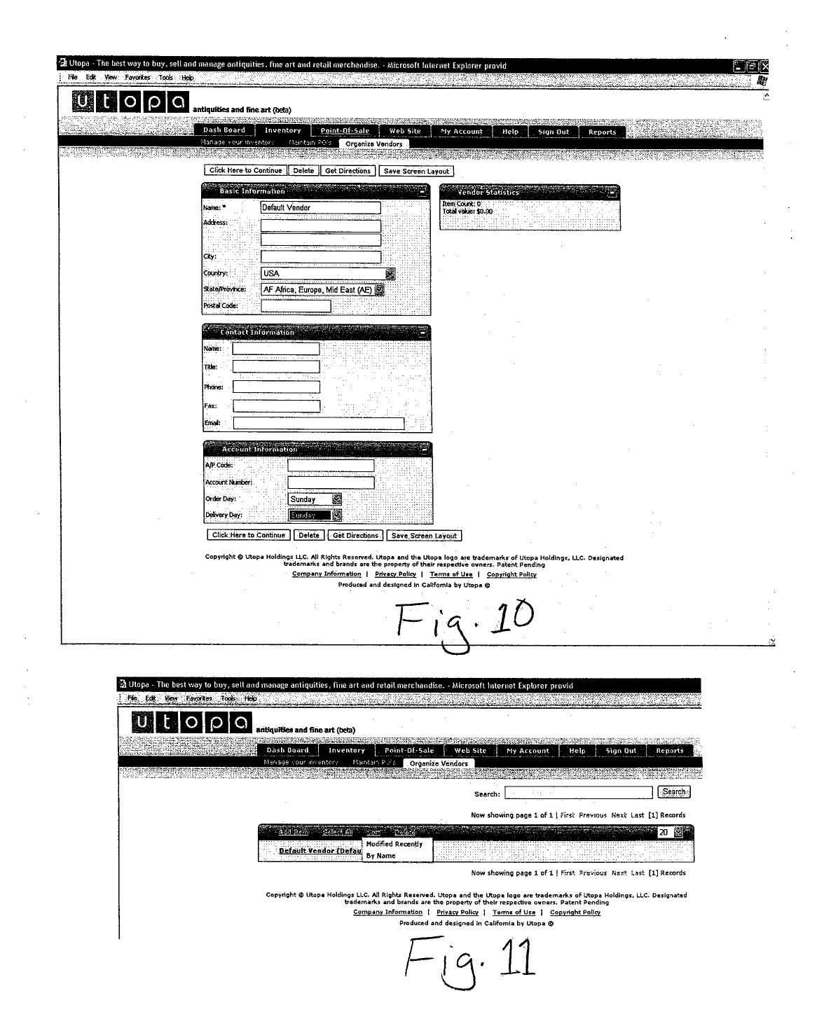

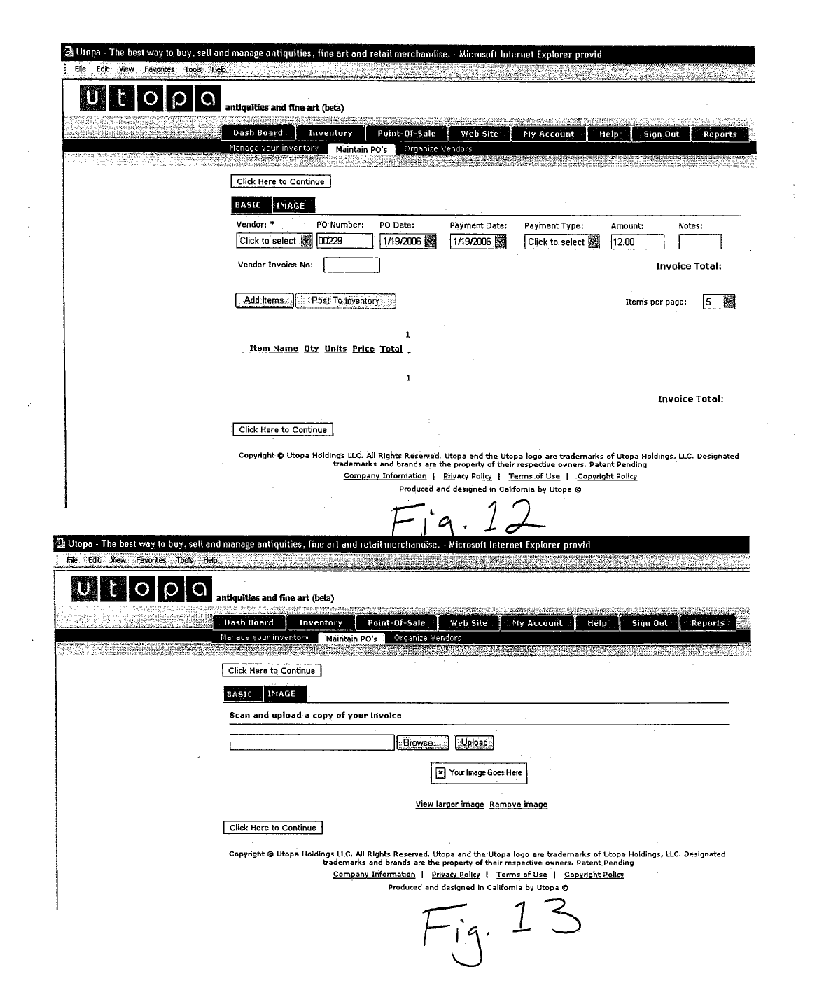

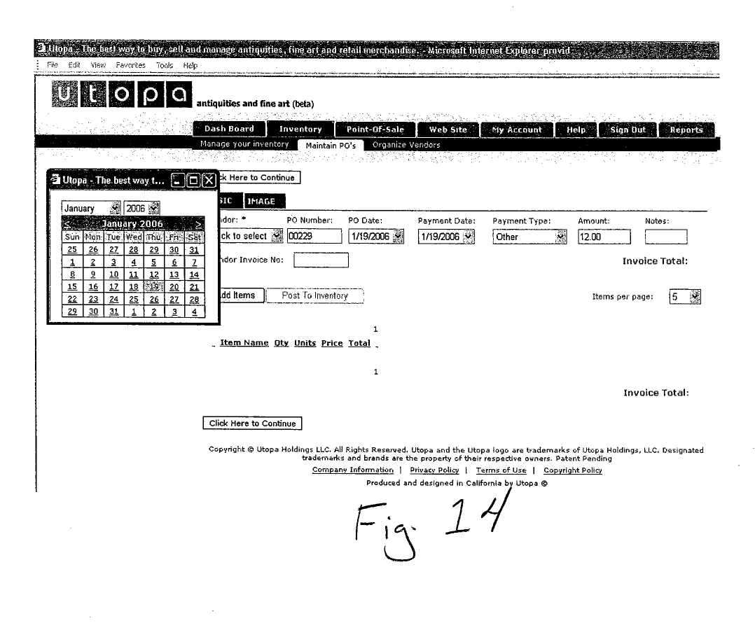

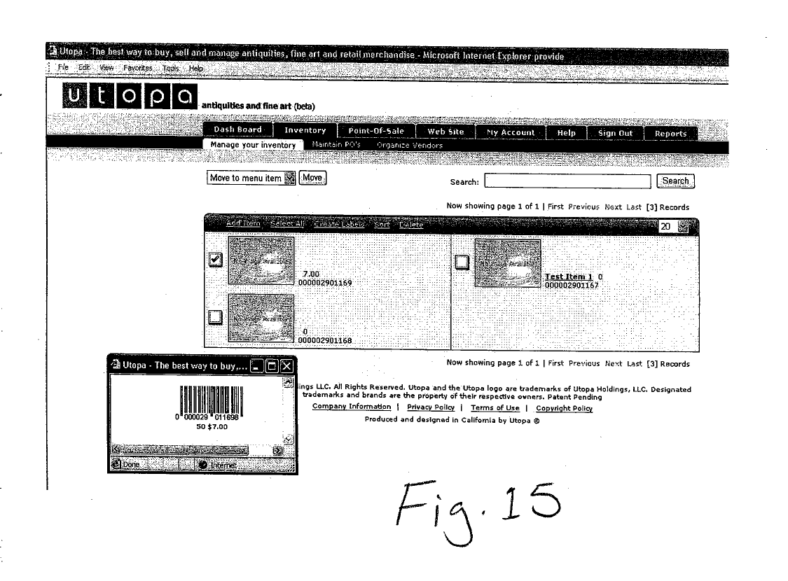

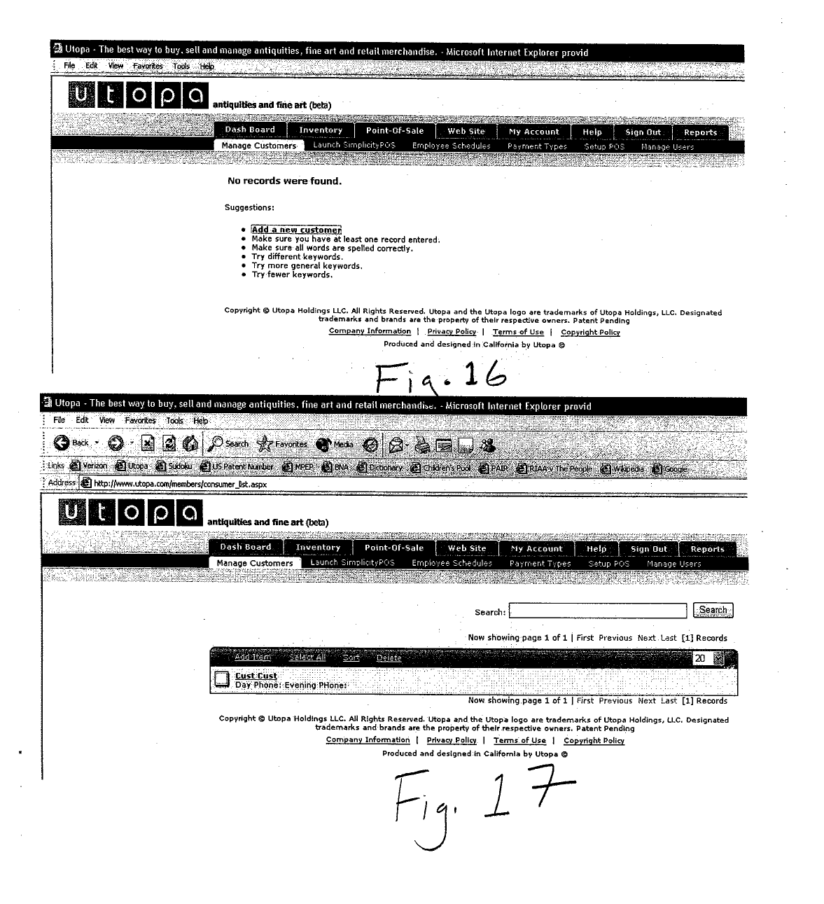

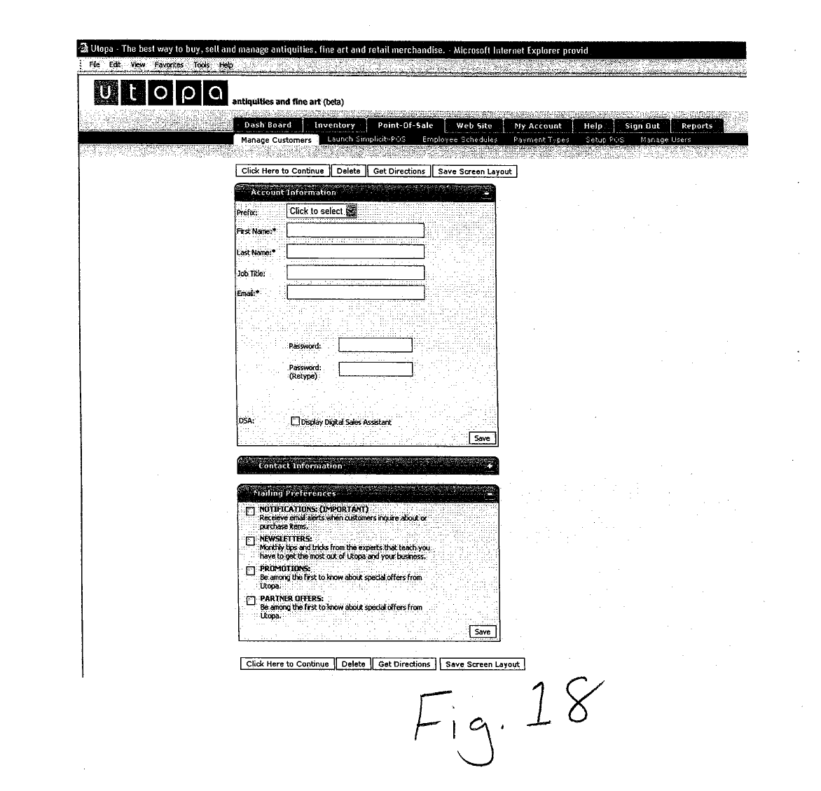

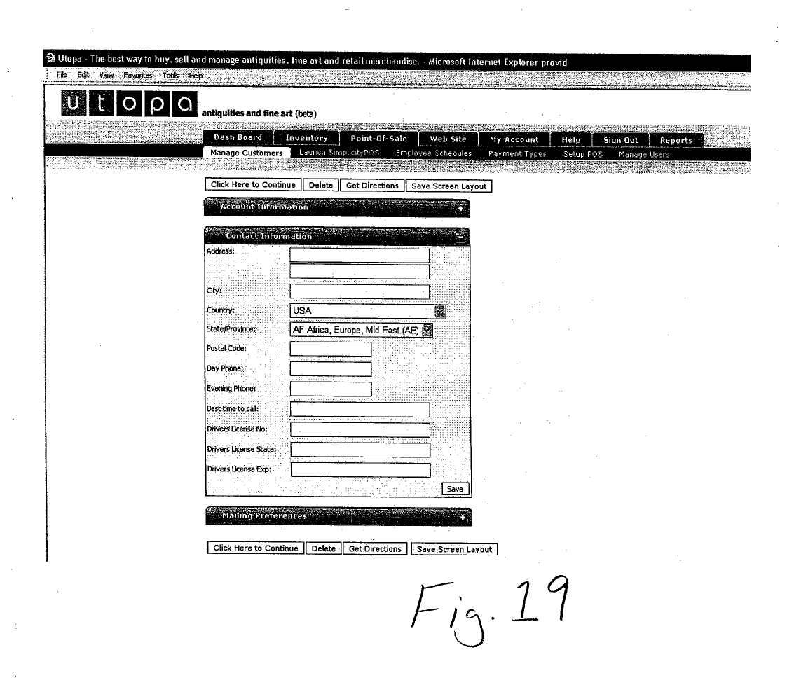

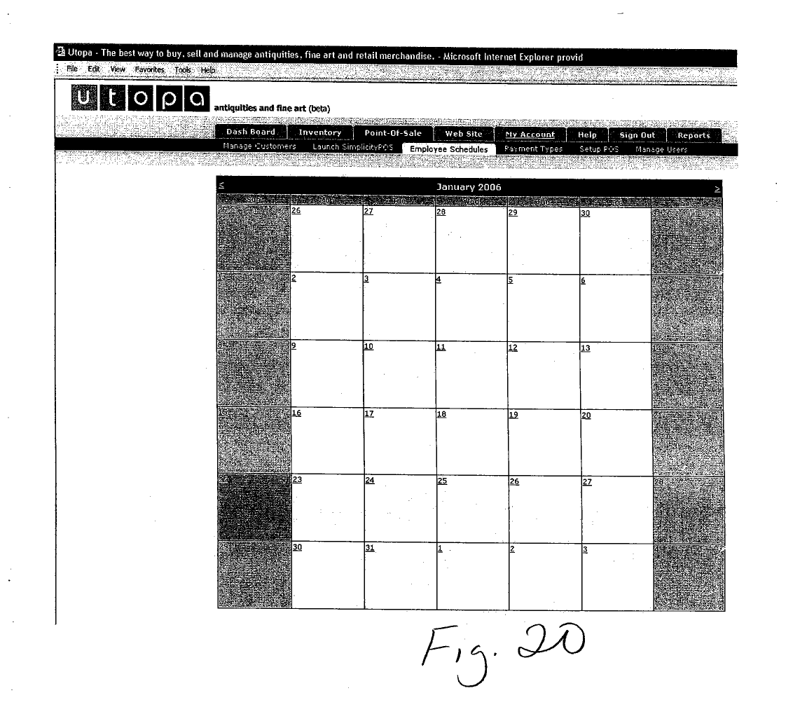

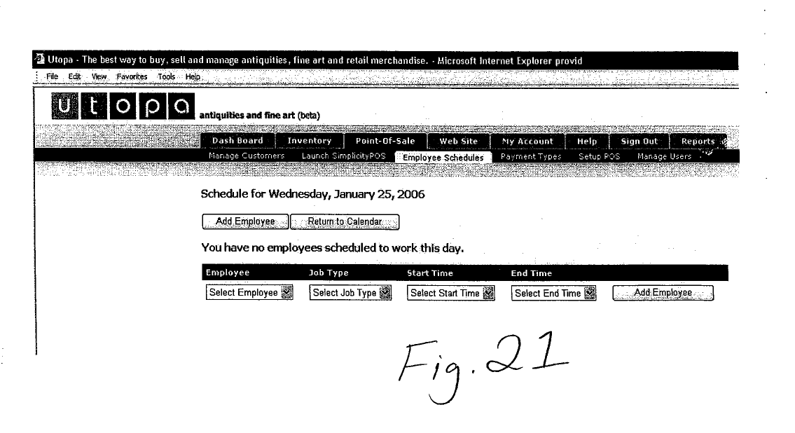

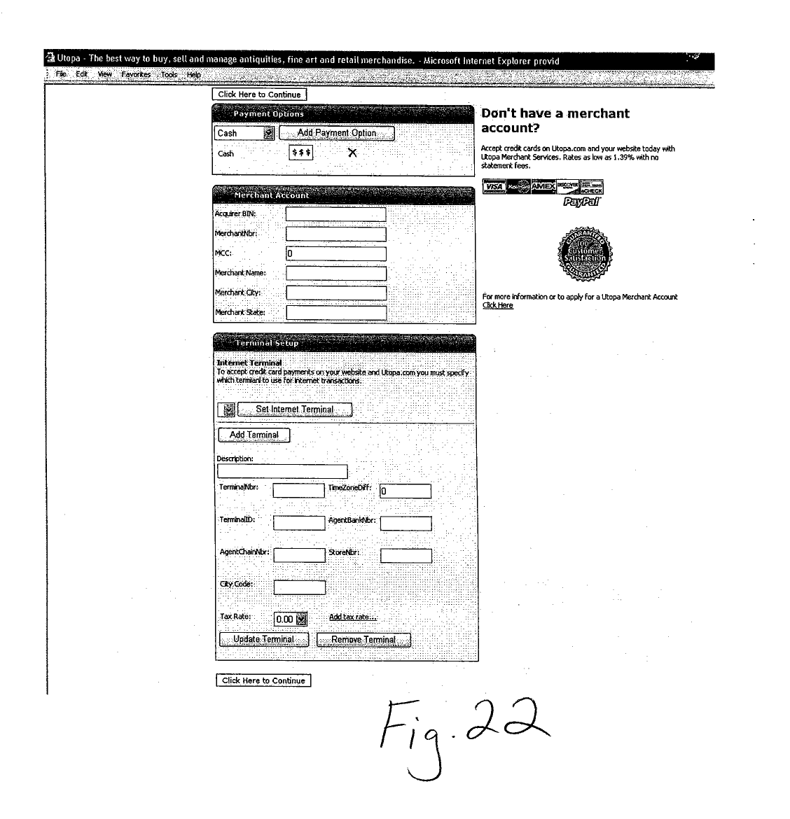

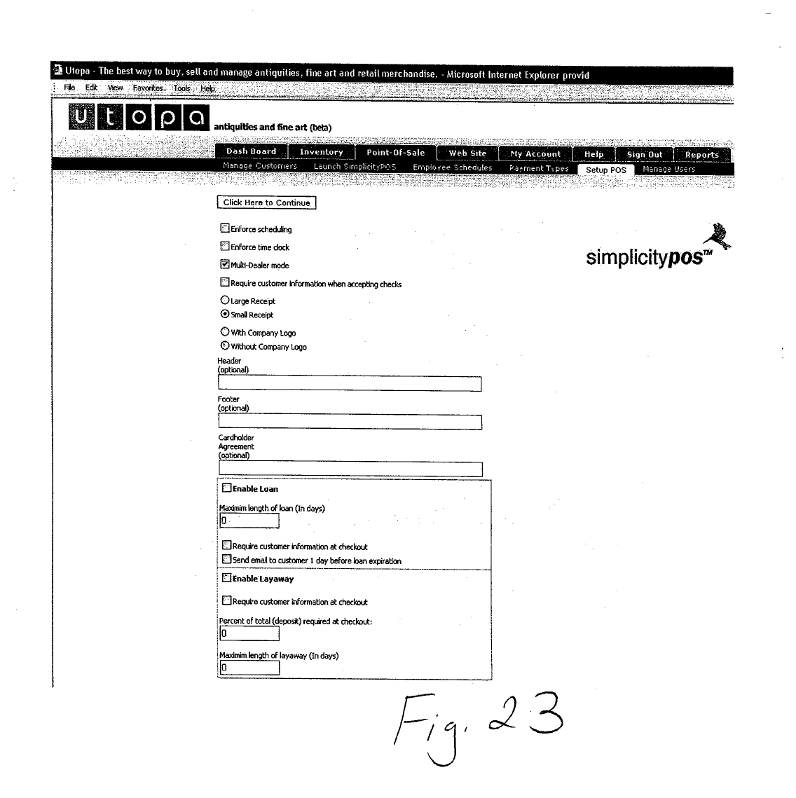

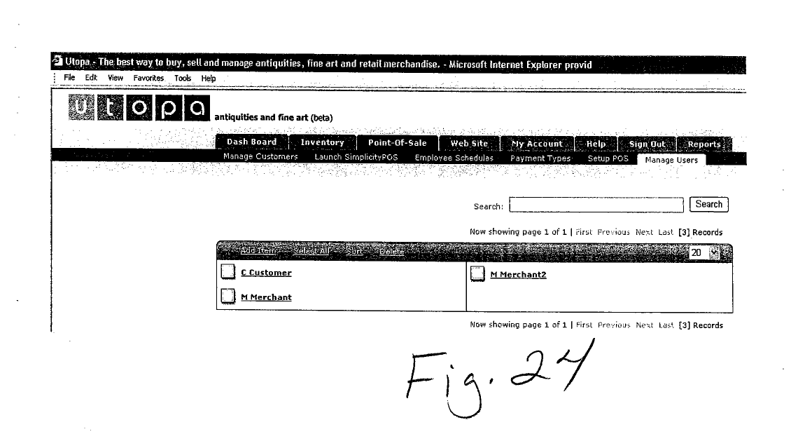

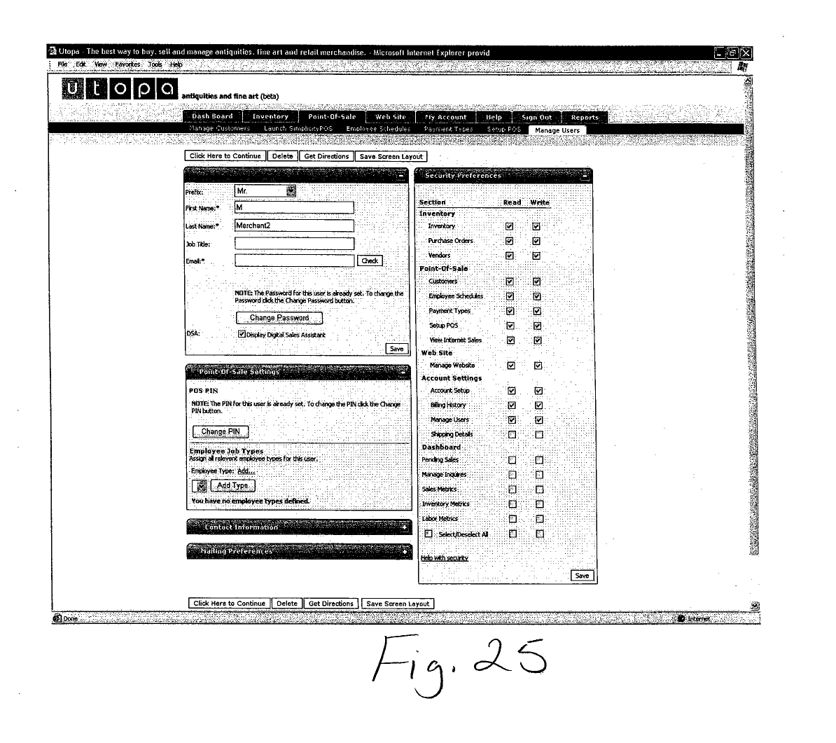

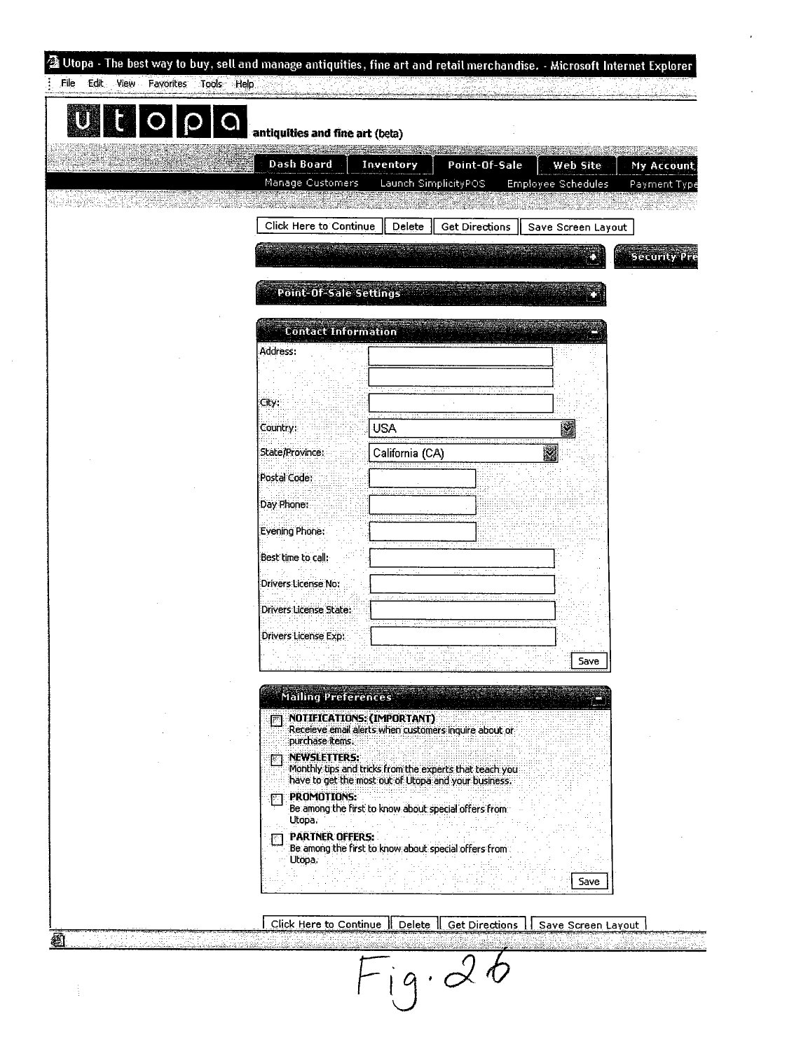

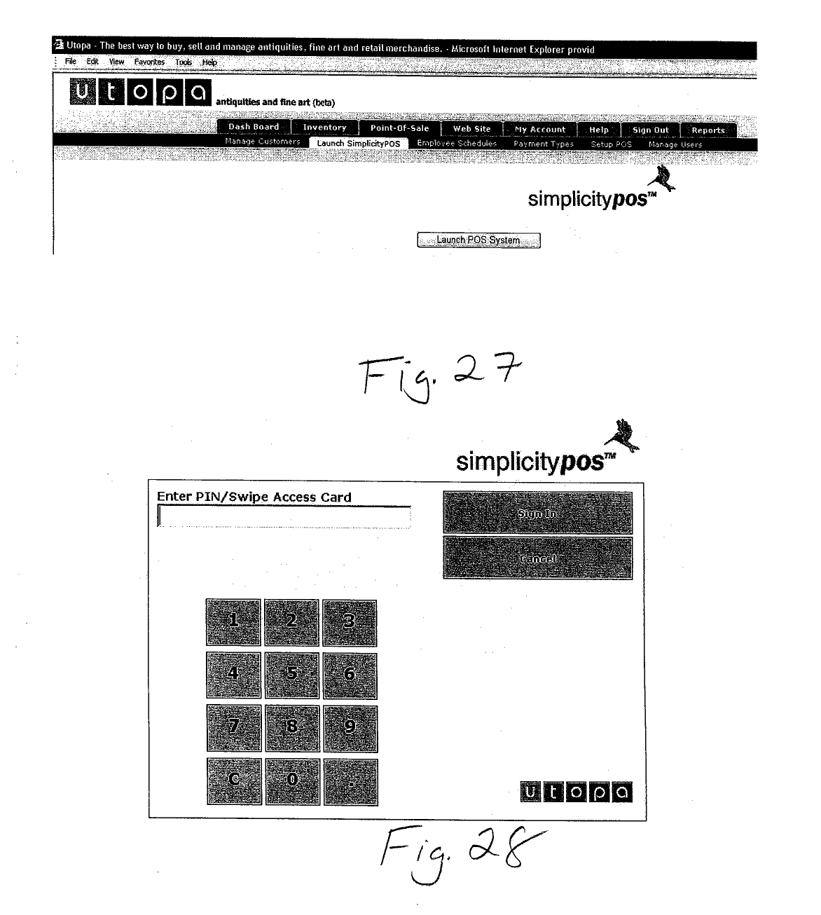

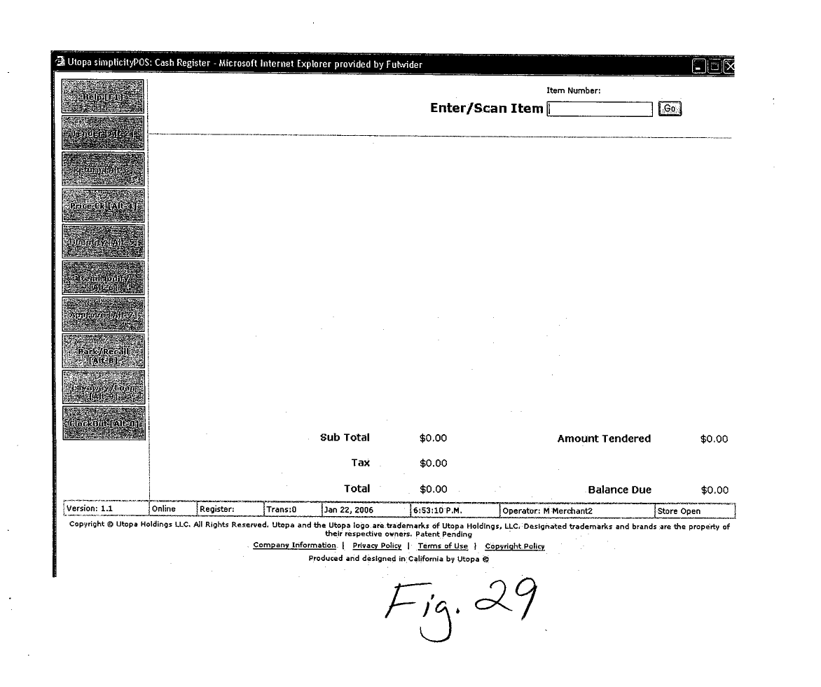

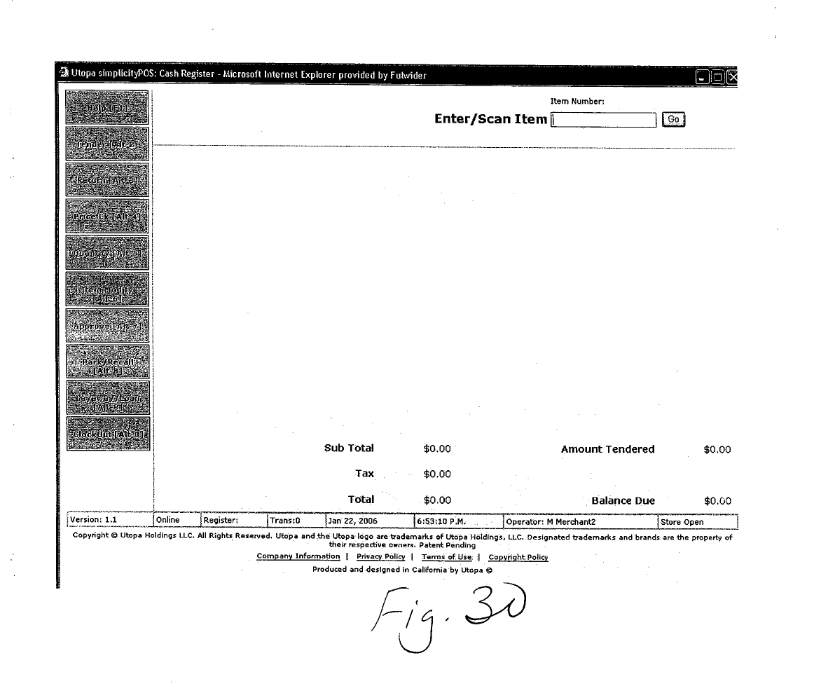

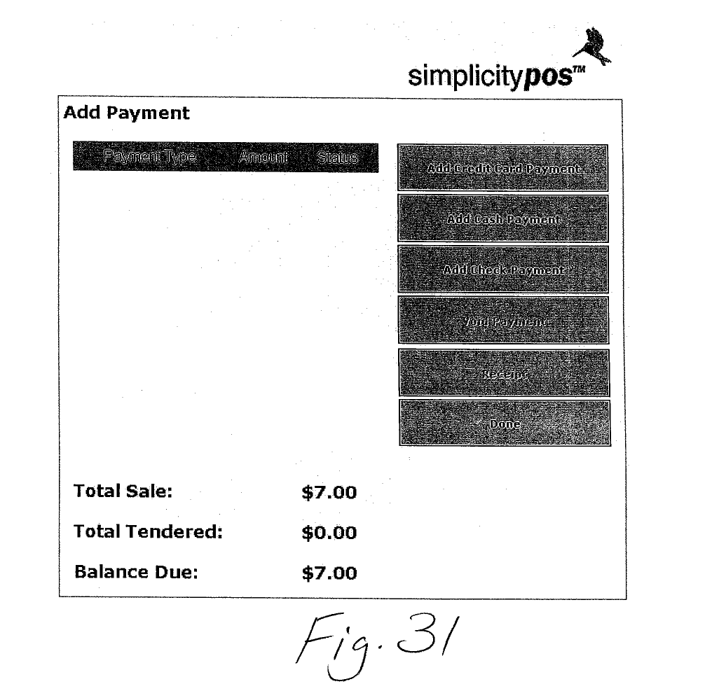

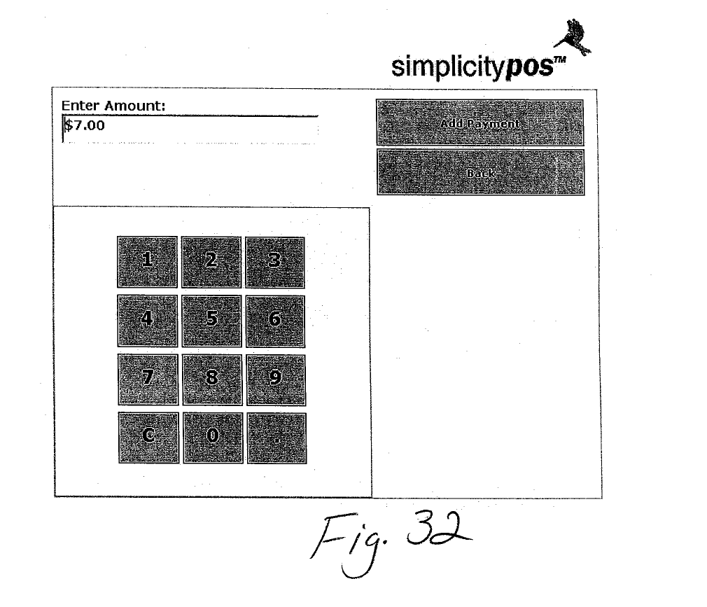

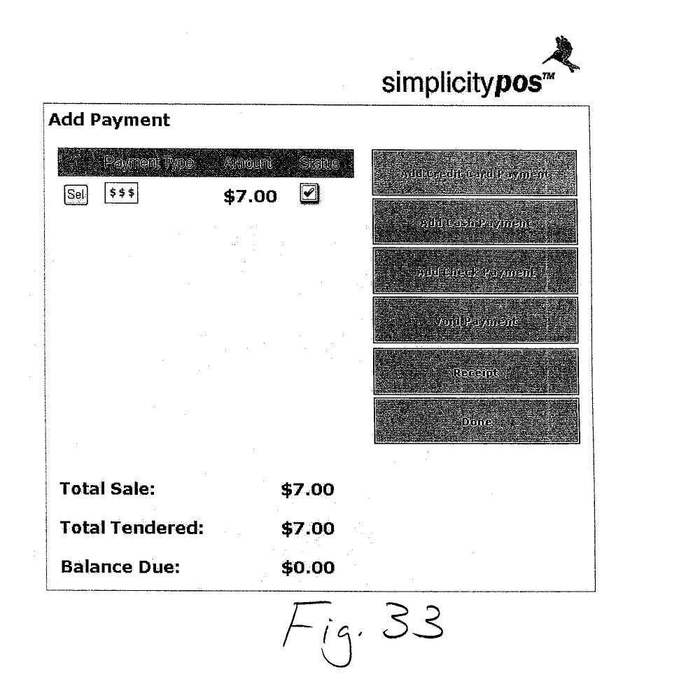

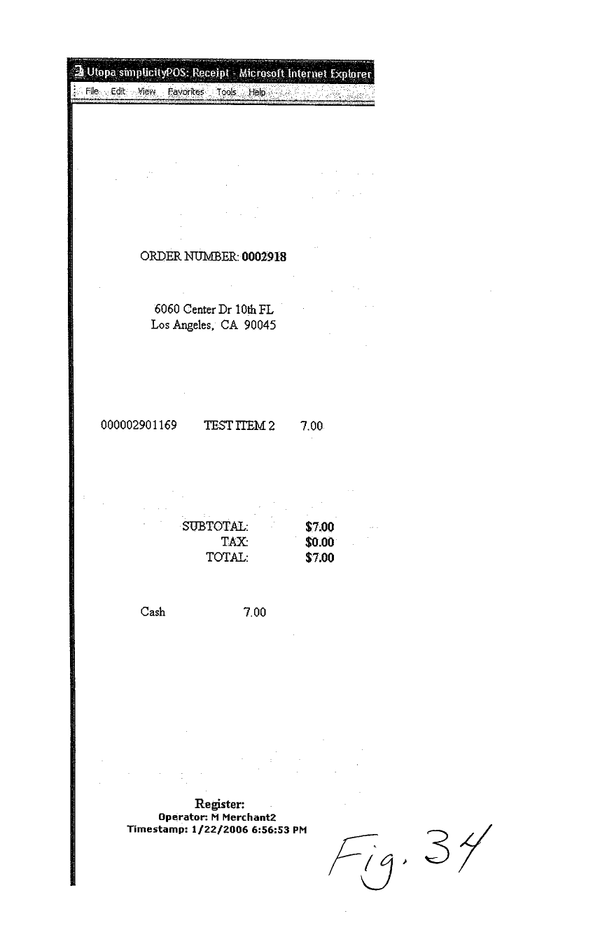

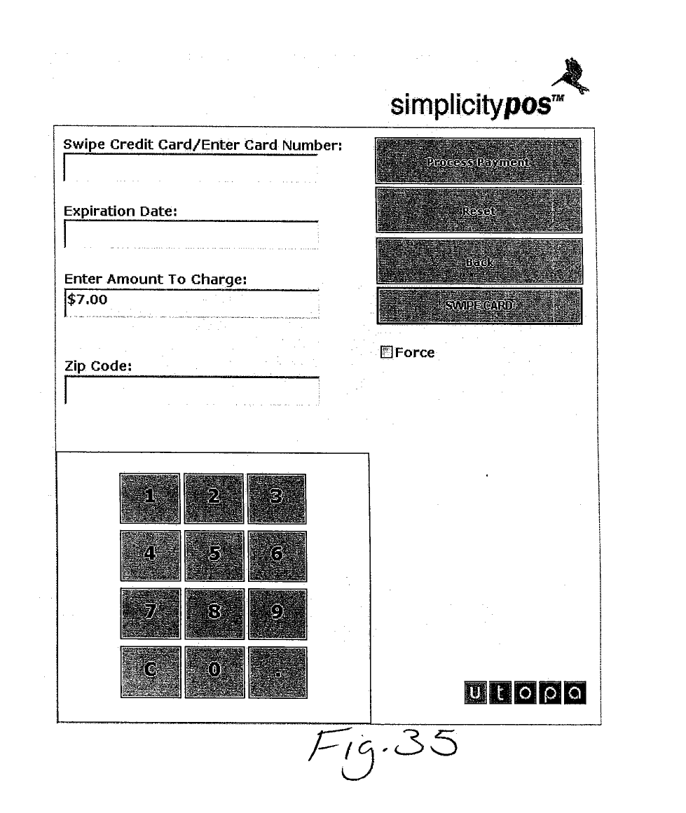

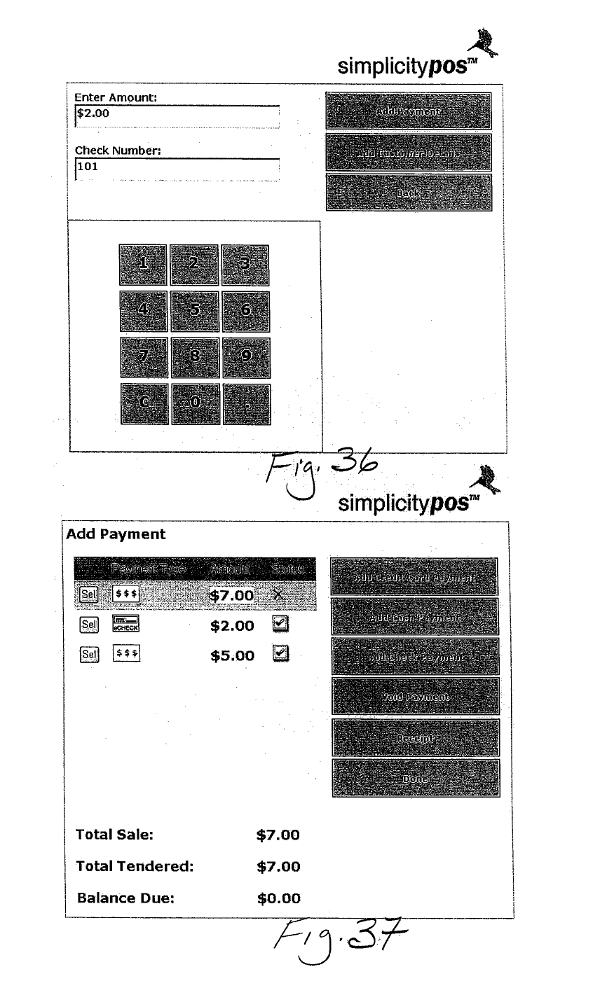

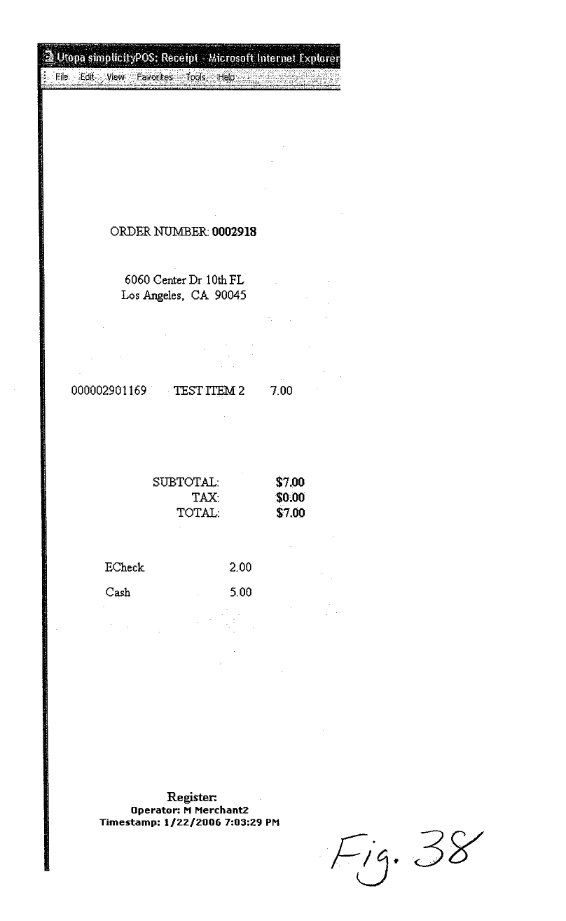

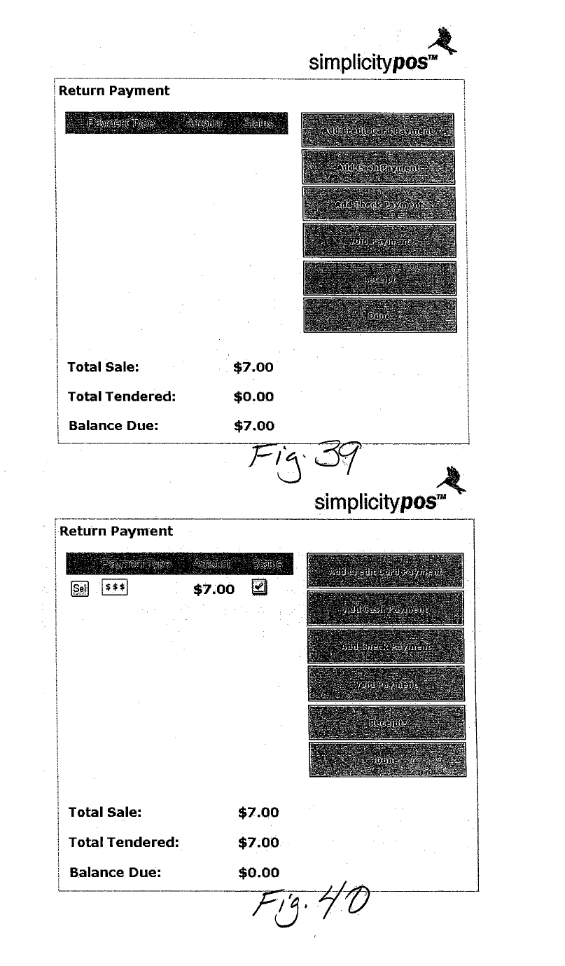

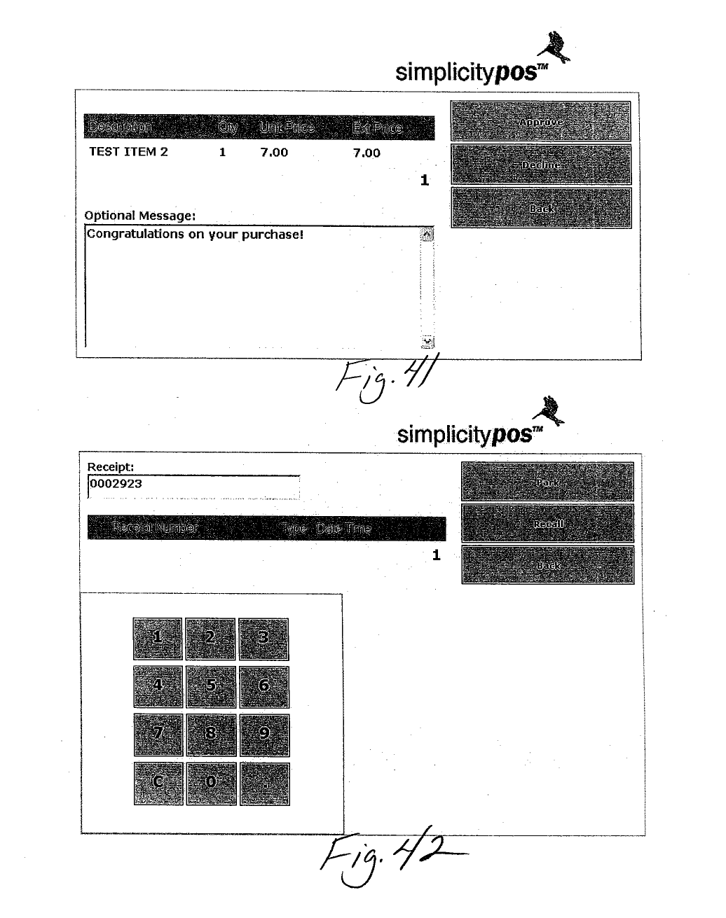

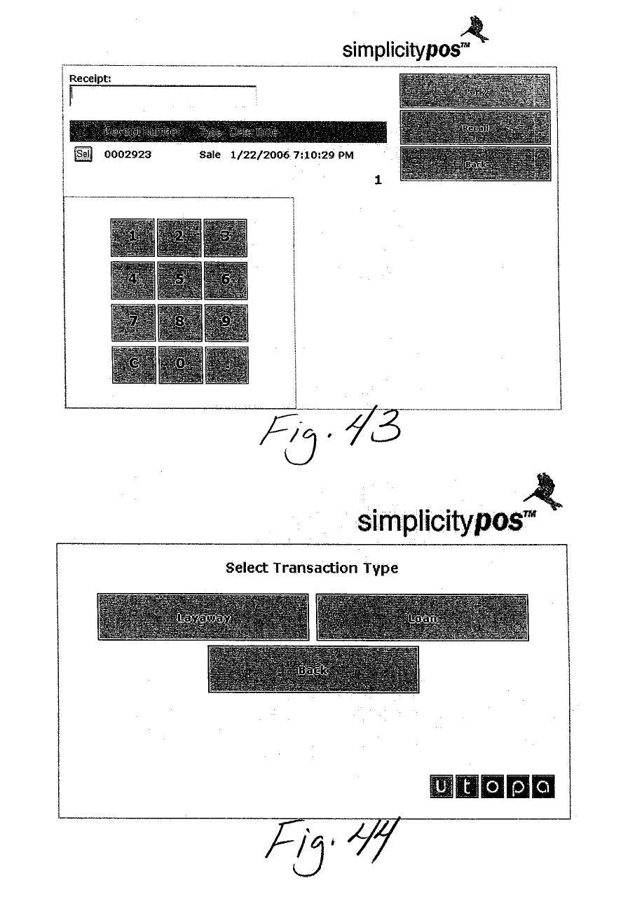

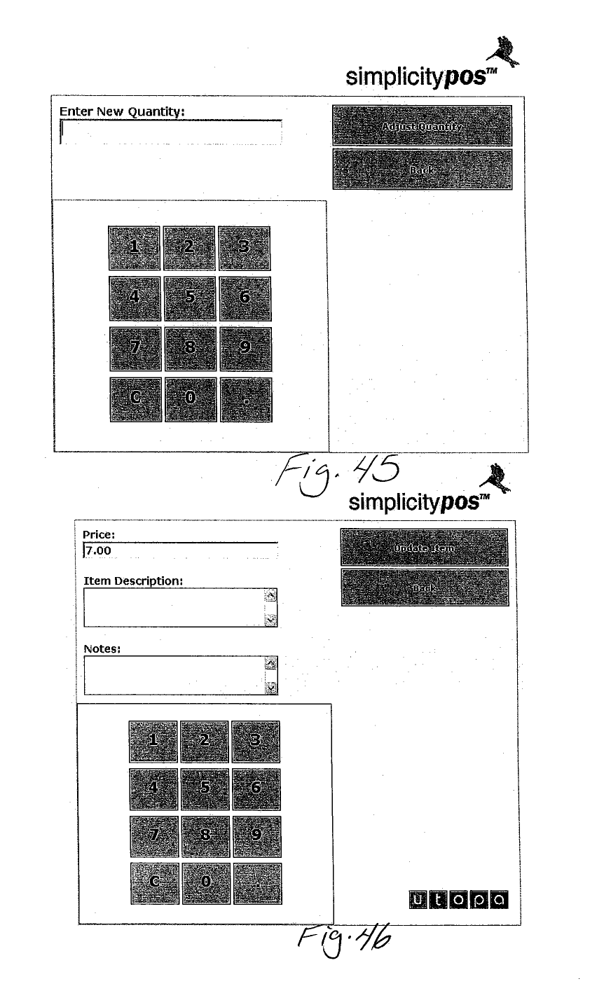

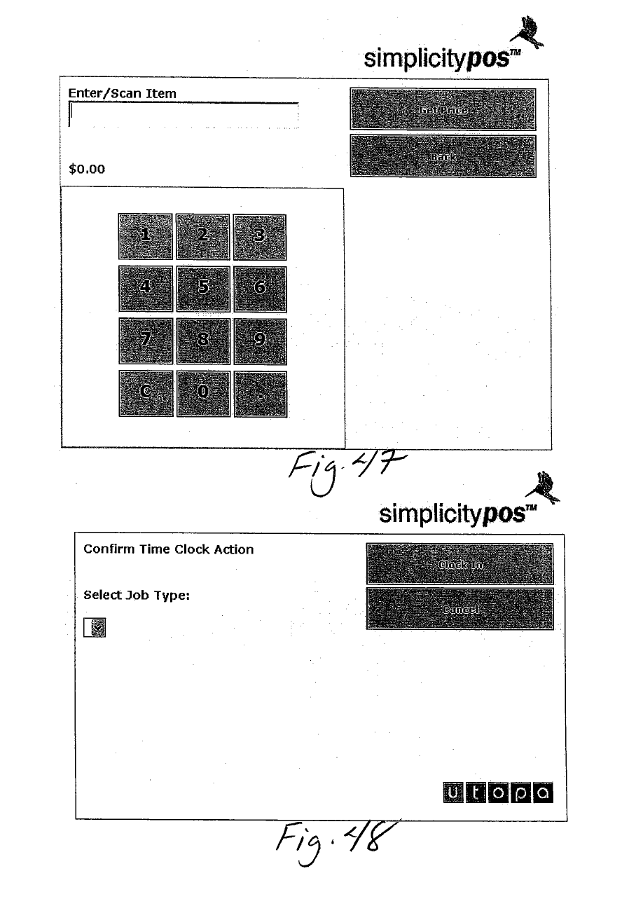

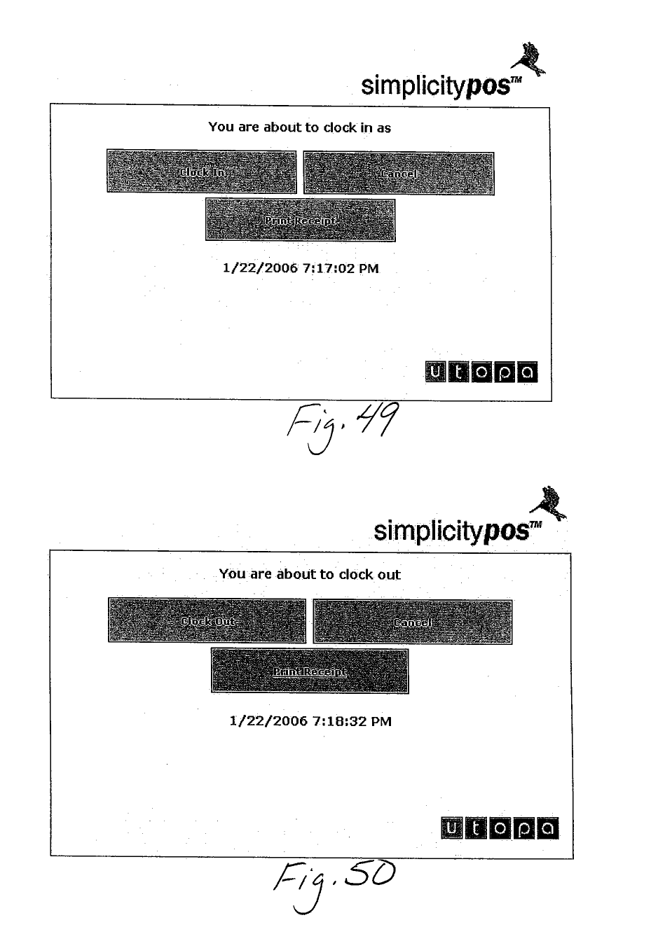

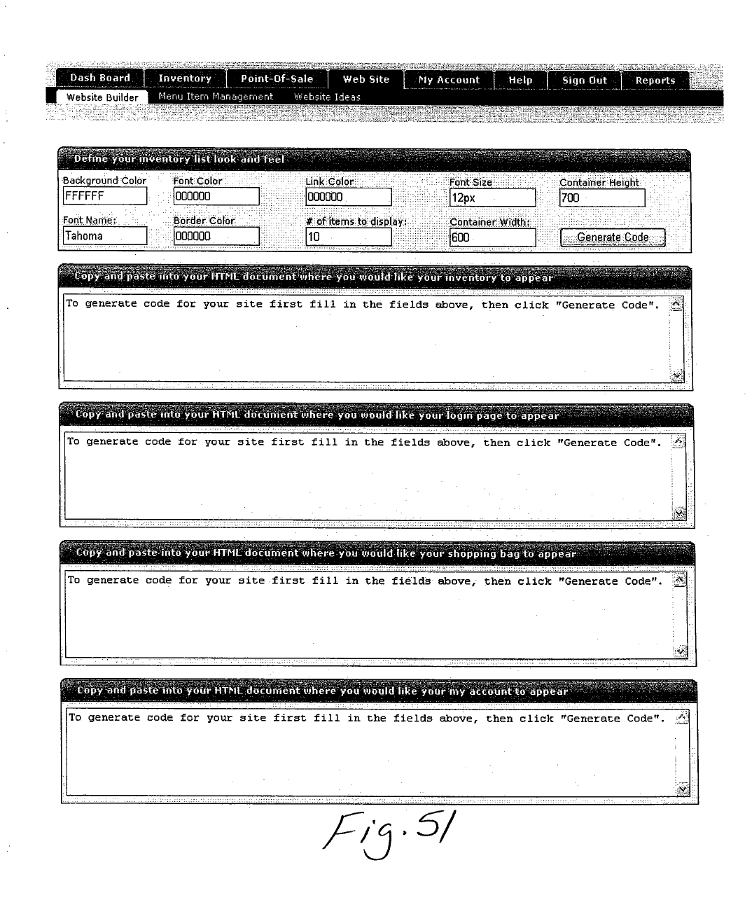

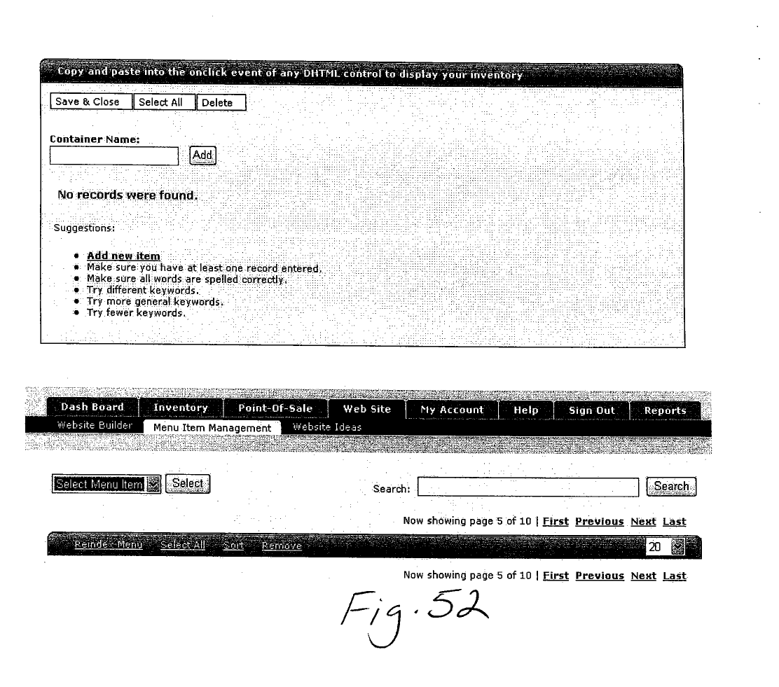

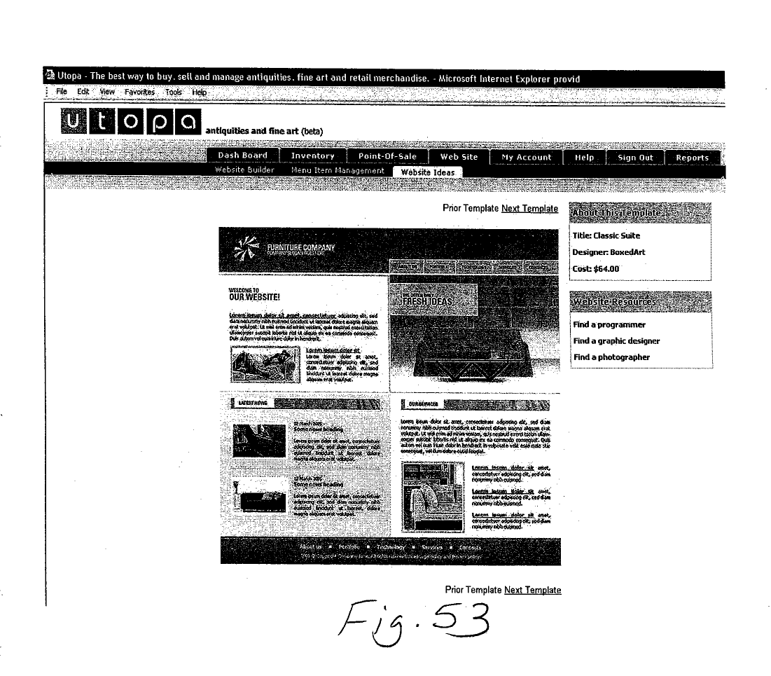

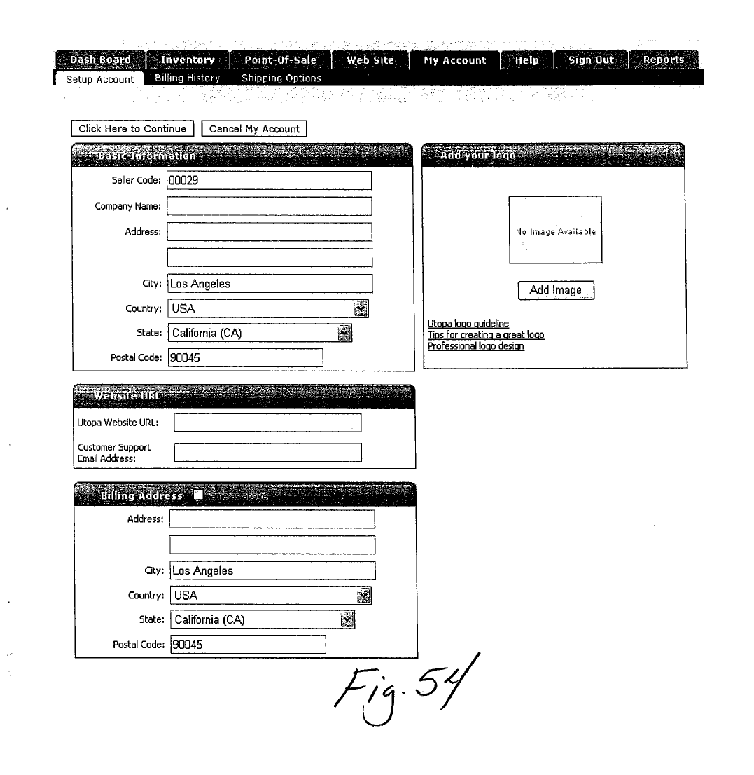

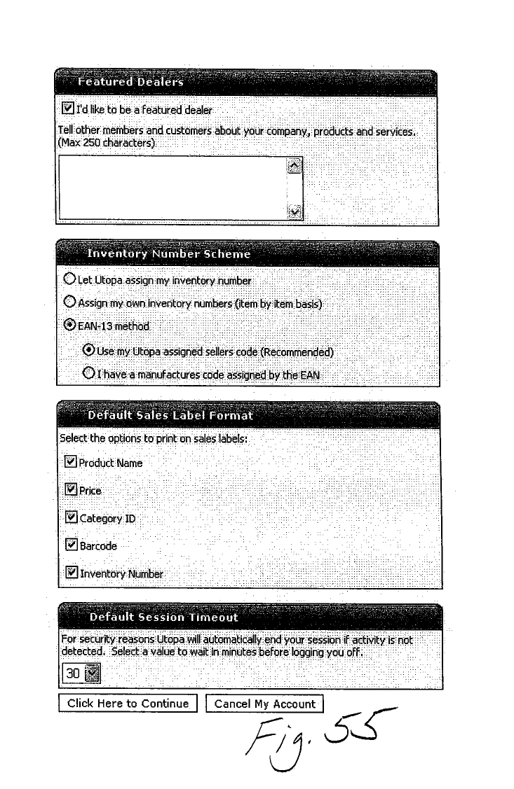

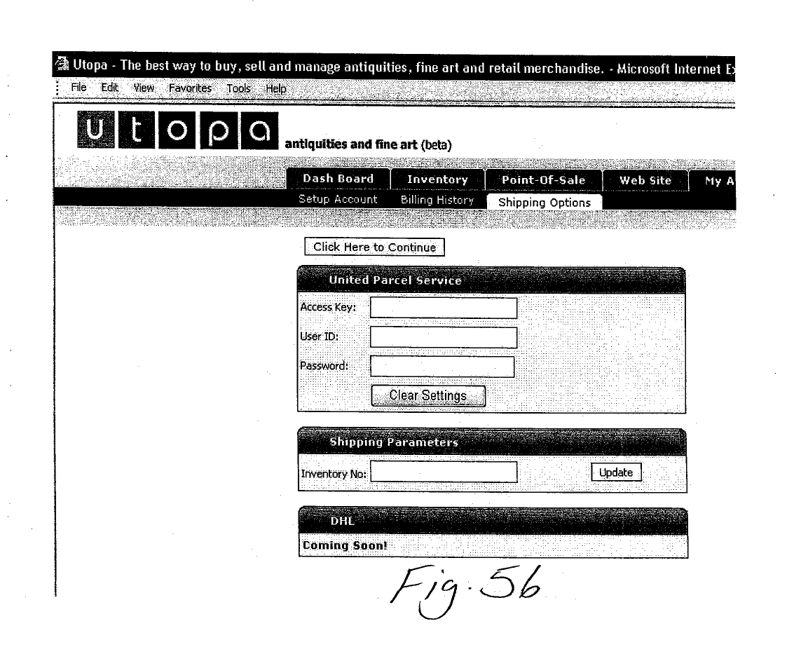

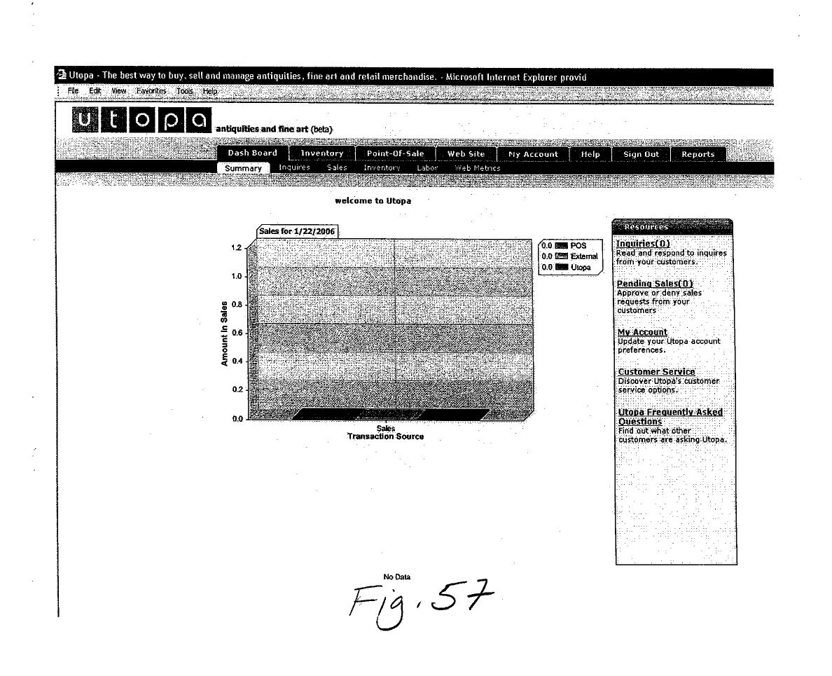

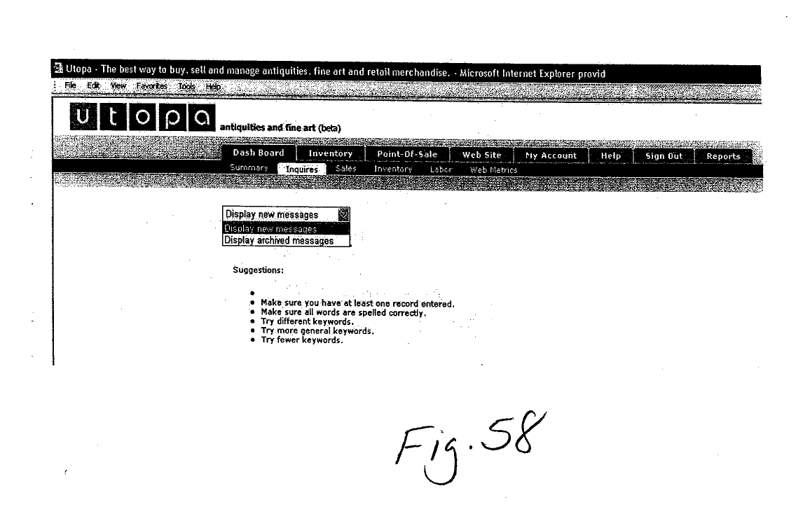

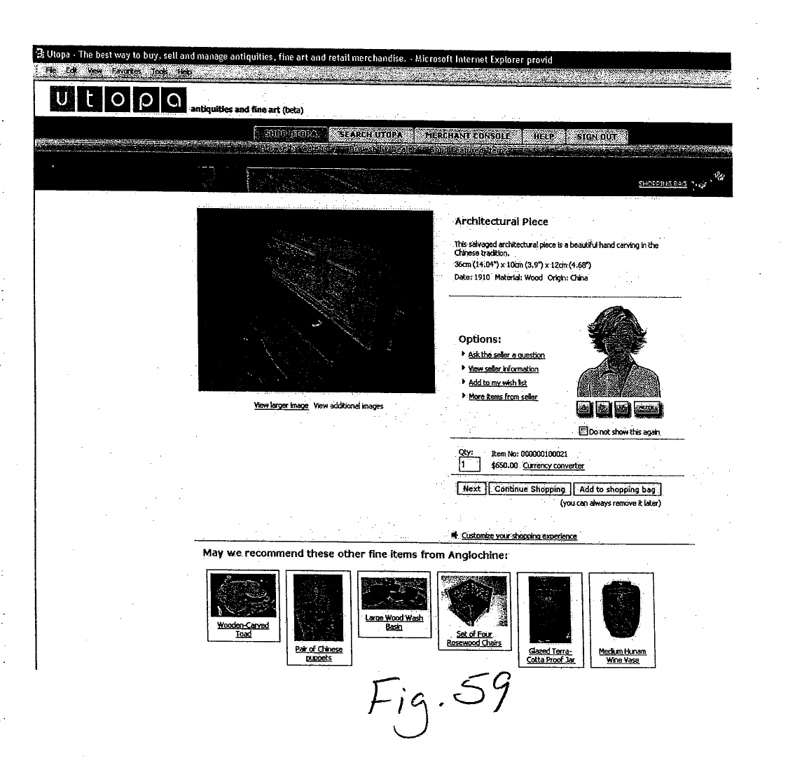

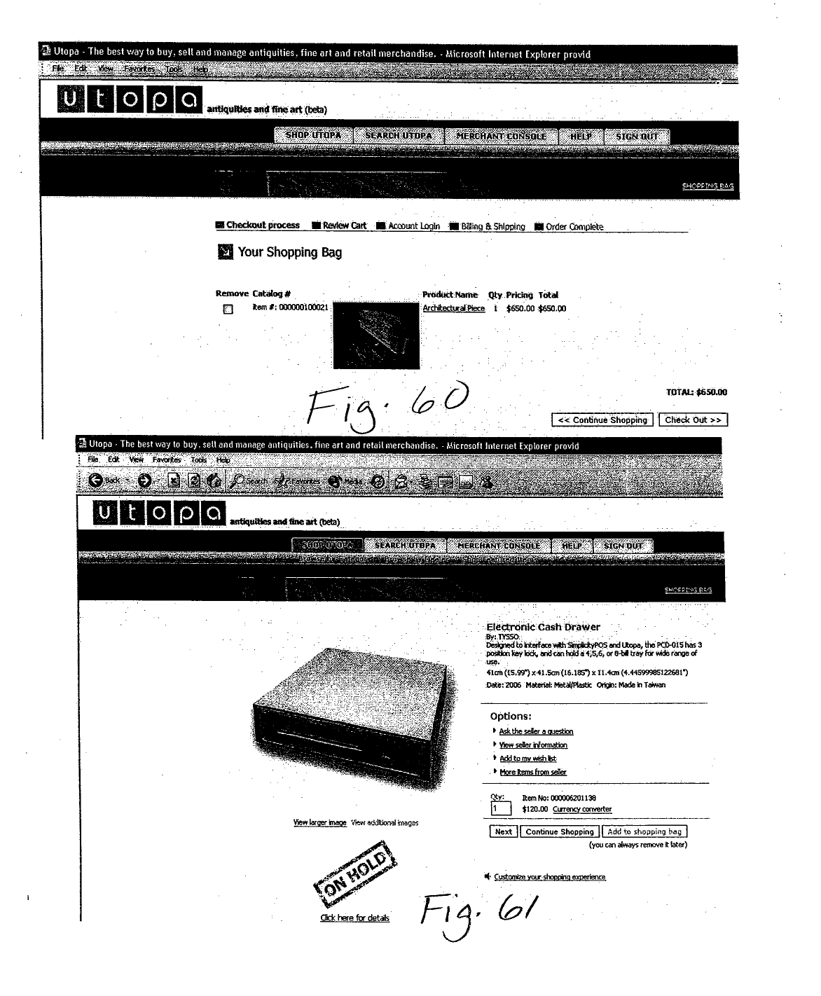

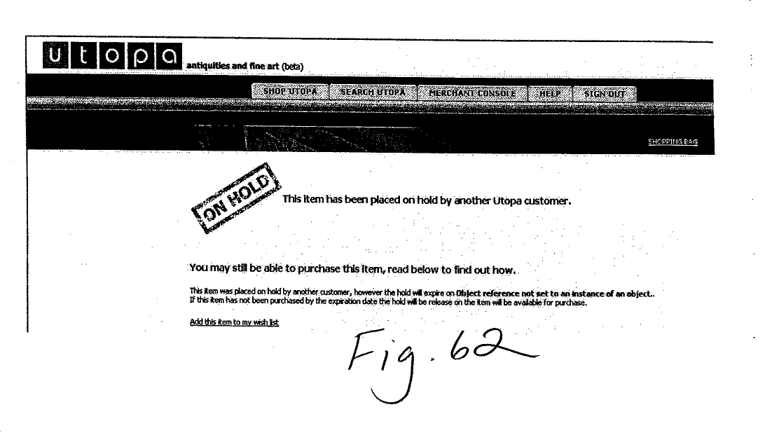

The system is a platform in which a merchant can manage and sell its goods. Referring to FIGS. 1-15, the first step in utilizing the system is to enter an item into inventory. Once an item is in inventory the merchant has many options. The merchant can, if he has a retail store, sell the item in its retail store. If he has a website (also referred to an “external website”) he may sell it on his website, and he can also list the item on the online mall, UTOPA.com, where a consumer can then search for and purchase the item.

The inventory allows for management of one-of-a-kind items. If the merchant has a one-of-a-kind item, for example, a one of kind antique lamp listed for sale in its store, on the merchant's website and on UTOPA.com. If a customer purchases that item through any of those places, the system automatically removes that item as being available for sale, and the item would not be available for purchase anywhere else. The item is taken out of inventory automatically by the system.

The merchant does not have to concern himself with taking the item out of its inventory or making sure the item is removed from the merchant's website. After the sale is made and the item is purchased, the item is removed from the web and from all the stores.

Several steps mediate the above described process. Typically, in the area of collectibles, antiques and one-of-a-kinds, the businesses that buy and sell these items are small, often run by one or two people and often do not have a showroom. If a one-of-a-kind item is sold online and it is located in a store, the employees at the store might not necessarily know that that item was sold online, and it could be sold again at the store. When a customer buys an item either on a merchant's website or through a mall, the system does not allow the sale to be completed. The system places the item on hold. In an embodiment, a hold is placed on the item automatically for 48 hours. When a customer views an item online that has been placed on hold, a large “on hold” sign is displayed. The sign communicates to the customer that they still may be able to purchase the item and it tells them the time and the date that the hold expires.

Referring to FIGS. 16-50, the system includes a point of sale system (POS). If an item is placed on hold, the item cannot be sold through the point of sale system, and no one else can purchase it through any other avenue, such as at the merchant's own website or the UTOPA.com mall. The hold will automatically expire after a predetermined length of time. A hold manager acts as an internal mechanism that runs constantly in the background on a server and it manages the holds that have been placed on all items and the hold manager is responsible for placing and removing the holds.

When a customer requests to purchase an item, an e-mail is sent to the merchant and an e -mail is sent to the customer, if the customer has authorized communication by e-mail. A customer also has the ability to place any item in “wish list,” which allows the customer to monitor many items of interest.

Once a purchase has been finalized, the customer may elect to have the item shipped. The system is integrated with various shipping entities, such as Untied Parcel Service, Federal Express and the United States Postal Service. The system captures from the user the address of the destination where the item is being shipped after a purchase request. Whether through UTOPA.com or a merchant's website, when a customer requests the purchase of an item, the system will query them for the address to which that item is to be shipped. If that address has not been used in the system before, it is saved into a holding area so that the customer can automatically use, without reentering, that address in the future. Once the system has the customer's address, the system will query the shipping entity for confirmation of the validity of the address. The shipping entity will either confirm or deny a valid address. If it is not a valid address, the system will tell the customer, the address cannot be verified. The system will then ask the customer whether they would you like to use the address anyway, or would the customer like to correct the address. If they elect to use the address, it is saved in the system and associated with the customer.

Once the shipping information is entered and before the customer can confirm the sale, a message appears to the customer notifying the customer that he is about to agree to contract to buy that item from the merchant. When a customer confirms a sale of an item, that item is no longer allowed to be sold. A merchant could suffer damage if the consumer does not follow through. Next, the customer clicks the confirm button to complete the transaction, after which the item is placed on hold, e-mails are sent to the merchant and the customer, and the process is terminated.

When the customer clicks on the button confirming the sale, the item may be placed on hold if the merchant has exercised the option to automatically place the item on hold when a customer seeks to confirm a purchase.

Before a customer can complete a transaction, they must have an account in the system. The account is accessible to UTOPA.com, a merchant's external website, or their retail store. Therefore, a customer must have and may create an account whether using UTOPA.com or the merchant's external website. If a customer selects an item to purchase, clicks the item, and adds it to the customer's shopping basket, and does not have an account, the system will prompt the customer to login. In order to login, the customer must provide an e-mail address and a password. If the customer does not have an e-mail address or password in the system, the customer can click a box labeled, “I'm a new customer.” The customer may then provide an e-mail and a password, and the customer may continue shopping. At a later time the customer can input billing and shipping information into their account. The system does not require billing and shipping information at that point, so as not to deter the customer from continuing to shop.

When the item is placed in the basket and “proceed to checkout” is clicked, the system will prompt the customer for their e-mail address and password. If the customer has an account they may enter their e-mail address and password. If the customer does not have an e-mail address and password in the system, they may click a checkbox directly underneath the password dialog box that is label, “I'm a new customer.” When the checkbox is clicked, underneath the box a field to add a password appears. The customer enters their password and clicks continue. An account is created, and the customer is allowed to proceed to the confirmation section.

When the customer is prompted to review the items they are about to purchase, the customer's shipping information is displayed at the top of the page, and automatically entered in the proper field, if the particular customer has previously entered his shipping information. The customer also has the option to modify the shipping information it. The first time any customer uses the system, the shipping information will necessarily be blank. After a customer has had an item shipped, the system automatically will pre-populate the shipping information fields for subsequent purchases.

After the customer has requested to purchase an item, and has an account established, the merchant is made aware of the customer's attempt to purchase the item by e-mail or by logging into the system and checking the merchant's account. If the item has been placed on hold, the merchant may make a decision on whether or not the merchant wants to release the item for sale. The merchant may release the item for sale or they may decline the sale of the item to the consumer. In either case, if they approve or decline the sale, the merchant may include with that decision a message to the consumer. In addition, if the merchant approves the sale, the hold manager resets the hold time for a length of time, for example, forty-eight hours.

The above described process is completely integrated with the simplicity point of sale component of the system.

The consumer, by virtue of creating an account on the system, has account utilities, which are several tools that are available to them when they log in to manage their account. One of the tools in the account utility section is the “view pending purchases” tool. When the customer clicks on “view pending purchases,” a list of pending purchases is displayed. Any item that he has requested to buy that is pending (having been confirmed by the customer, but not yet approved or declined by the merchant) will appear on the list and with a red rubber stamp graphic on the right portion of the screen that displays status. The stamp would display “pending,” if, for example, the item is pending. If the item is approved, the rubber stamp with the word “approved” is displayed next to the item and a button will appear underneath it, labeled “purchase this item now”. The item will appear in the pending list for the duration of the time the item is on hold. When the hold expires the item is removed from the list.

If the merchant has approved the sale, the hold manager will reset the hold time and the item will appear in the customer's list of purchased items with the status of “approved”. If and item has been approved or is pending and the hold time expires, the item is removed from the list, and the item is again marked as available for sale. If the merchant has declined a sale, and the customer views his pending orders list, the customer will see an indication that the sale has been declined and the system will automatically remove the item from their pending orders list after the customer has viewed his pending items list. The item will not appear in the list in future viewings by the customer, unless the item is involved in a new transaction. For items declined by a merchant, the system allows the customer to view the declined times one time in the pending orders list. If the merchant has elected to send an optional message to the customer, the optional message will appear on the pending list as well.

If an item has been requested for purchase and the merchant has approved the purchase, the customer may buy the item by clicking a button labeled “purchase this item now” on the pending orders list. If the customer purchases the item on UTOPA.com, the system displays a customer information page that captures the customer's information, such as billing and shipping information. If the customer makes the purchase on an external website, a click of the “buy now” button launches a separate page that displays the customer information page. The separate page allows the system to maintain control of the financial aspects of the transaction as well as provide security socket layer (SSL) technology to the transaction, when the purchase initiates through an external website. Both will take the customer to the system's check out page.

Many websites have a rating system for purchasers. For example, if a customer agrees to purchase an item and breaches that agreement by failing to purchase that item, the customer is scored so that other users of the website will have an indication of the purchasing behavior of that customer. The system method also has a method for scoring customers, and the merchants may use a customer's score as a factor in their decision to release an item agreed to be purchased by a customer. The system scores customers as follows. If a customer has agreed to purchase an item, and a merchant has approved the sale of an item, and the customer does not complete the sale before the hold expires, a score of zero added to the customer's point total, and a transaction tally is incremented by one. If the customer completes a purchase, then a score of four is added to the customer's point total, and the transaction tally is incremented by one. The customer's score is determined by dividing the customer's point total by the transaction tally. A customer with a zero transaction tally has, by definition, a score of four. The system provides a customer's score to a merchant and thus assists the merchant in determining the likelihood of whether their item, which may be a unique item, will be purchased by this individual.

Prior to the tender of the payment, several processes occur. The system is capable of accepting multiple forms or methods of payment. The methods of payment are defined by each individual merchant. The methods of payment may include cash, Visa, Master Card, Discovery, American Express, Diner's Club, Pay Pal, etc. In order to accept credit cards and have credit cards displayed on a merchant's checkout page on UTOPA.com or an external website, the merchant must have its own merchant account or merchant bank account. The system offers the merchant a merchant account. The merchant may enter its banking identification information and the system will display credit card options.

The system's display of payment options varies among merchants One merchant may not accept credit cards and only accept Pay Pal. In that case, PayPal is the only payment option that will appear. Referring to FIG. 22, within the system, a merchant may define one or more terminals. A terminal is used to accept a credit card payment and can be anything from a computer to a card reader. Each terminal has information pertaining to that terminal, such as a city code, state code, an acquirer bin, and merchant numbers, information that a terminal requires in order to process a credit transaction and route it to the appropriate bank.

A merchant may set up numerous terminals, virtual or physical, each with separate terminal information. The UTOPA.com website utilizes virtual terminals and one of the merchant's terminals is designated for internet use, for use on UTOPA.com and on an external website. This configuration allows a merchant to consolidate their merchant accounts into one account. For example, through the system, a merchant can accept credit cards on an external website, on the UTOPA.com online mall, and in their retail store, all using the same merchant account, rather than having several other separate merchant accounts, which many merchants have.

A merchant may add a terminal by clicking a button that labeled, “add terminal”. When the add terminal button is clicked, the terminal information is displayed and the merchant inputs the terminal information into the system. The merchant may designate the terminal as an internet terminal by clicking on the button labeled, “internet.” The merchant now has a terminal for accepting payments over the internet. For example, if a merchant wishes to accept Visa and Master Card, the merchant would acquire a merchant account from a merchant account provider, add a terminal by clicking the “add terminal” button and input the numbers provided by the merchant banking provider into the terminal fields. The merchant may define a method of payment from a list that contains all the methods of payment that UTOPA.com accepts, for example, cash, Visa, Master Card, Discover, American Express, PayPal, etc. The payment options that a merchant may accept is listed as options that appear at the checkout page on UTOPA.com, the external website and the point of sale in the merchant's retail store. All three sales avenues will therefore share the same methods of payment.

When a customer agrees to purchase an item by clicking the “purchase now” button, the customer proceeds to the checkout page which contains a list of the items he may purchase. After he clicks the purchase now button, the POS system creates the transaction. The item is placed on hold, and the transaction is accessible to the merchant in the POS system in the retail store as well as the merchant's website, allowing the customer to go to the retail store, tender payment and complete the transaction. For merchants that provide extremely expensive or large items that cannot be shipped readily, it is important to have one POS system that is responsible for all transactions anywhere in the retail store, the merchant's website, or UTOPA.com.

The system obviates the problem of an item potentially being purchased on the merchant's website, while a customer at the retail store has already purchased the item, or vice versa. Furthermore, a customer can purchase the item on the website, and the purchased item will appear in the retail store's POS system with the indication as having been purchased by the customer. The customer is able to pick up the purchased item at the retail store as if he had purchased the item in the retail store. Without resorting to multiple systems, the merchant has access to all of his transactions, in one system, thus making the business more efficient, providing customers with faster service and more options for completing the sale. For example, consider a merchant using the UTOPA POS system. A customer could agree to buy a sofa through the website, whereby the item is then placed on hold by the system. The customer may then go to the merchant's retail store and the merchant can access that transaction on his POS system and accept the payment for the transaction in the store, completing the transaction. Merchants who otherwise could not sell items online, either because they cannot be shipped or because they are also available for sale in the retail store, may do so with the system. A customer who purchases an item anywhere creates a single transaction that is accessible anywhere, i.e., the website, UTOPA.com or in the retail store.

Most merchants' online stores are completely disassociated with a point of sale system in the merchants' physical store or retail store. A merchant will have a store POS and a separate website POS, two separate systems that require managing. Typically, transactions involving items listed for sale in online stores take place in a completely separate process. The system would allow, for example, a customer to purchase on a merchant's website, a lamp, pillows and soap, three items in the transaction. The customer can go to any of the merchant's retail stores and the cashier can access the transaction, view the items purchased, and modify the transaction. For example, the cashier can apply a discount, increase or decrease the quantity of items bought, modify the shipping, or completely remove an item. The cashier has complete control over the transaction just as if the customer had initially transacted with the items in the store.

The POS system has a transaction engine that creates a transaction. When a customer purchases an item, a transaction is created and the transaction is made available to all aspects of the system. The state of the transaction can then be monitored by a state monitor. For example, if a transaction is created on the merchant's website, and the item being transacted is placed on hold, the state of the transaction is parked. Subsequently, the transaction's state is completed, declined, approved, or pending.

When a customer agrees to purchase an item online, a transaction is created and placed in “parked” status. The transaction in parked status remains on the system, in idle, and can be recalled with a click of a button. At the point of checkout, the transaction and the methods of payment are displayed to the customer to allow it to choose a method of payment. The customer may input his credit card information, PayPal or a combination of methods (i.e., split payments), click “continue” and the transaction is approved, placed on hold or declined.

If the payment method is approved, a confirmation page is displayed and the merchant may ship the item. If the payment method is declined, a decline page is displayed and the item remains on hold until another form of payment is accepted.

The transaction contains two parts. The first part is a transaction header, which contains envelope information about the transaction such as the merchant that owns the transaction, the merchant's vendor for the particular item being transacted, the date, tax amount, status, etc. The other parts of the transaction are transaction items details, which are line item details that belong to the transaction header such as quantity of items ordered. Each transaction will have only one transaction header but can have many detail records that belong to that header. Each detailed record represents an item on the order. When a transaction is created either on the website or a point of sale system in a retail store, a header is always created and detailed items are added to that header, representing each one of the items ordered.

After a method of payment is accepted, the transaction status is changed to “complete” and the sale is closed. Before an item is placed on hold, shipping information is captured so the merchant can query the shipping carrier to provide the cost of shipping and verify that the address is a valid address. When an item is entered into the inventory component of the system, the merchant has the option of using shipping integration, as shown in FIG. 56.

For example, UPS may provide the cost of shipping to the customer before he requests the purchase of an item. When a transaction is created, a line item for shipping is created in the transaction. The merchant may access the POS and adjust the shipping amount in the transaction. For example, if unforeseen circumstances require additional shipping, the price of shipping can be increased. If the merchant desires to provide free shipping, the shipping cost can be removed. For these reasons, the system captures shipping information before the item is placed on hold so that both the customer and merchant know the total price of an item and either can change their purchase decision or adjust the price. Since shipping varies with item weight, size and delivery date, the sale is impacted by shipping.

Shipping charges are calculated when the customer requests to purchase an item. When customer selects an item to purchase, he will add it to the virtual shopping cart and log in if he has not already. The customer may review the items selected for purchase and the system will display the shipping charges, which are calculated based on the weight, width, depth and height, the merchant's shipping address and the consumer's shipping address, which are all provided to the shipping carrier so that the carrier can provide a cost of shipping. At the customer's option, the customer may change the shipping method, after which the system will recalculate the shipping cost.

Item and item quantity management. The point of sale engine manages how an item appears on the online store and on the retail store's point of sale system, and controls item price. When a new item is added to inventory, a plurality of parameters about the item are available for input. The merchant has the option to be detailed and input many parameters or input few parameters. The minimum requirement for an item is a description and SKU number.

Referring to FIGS. 1-15, every item on the system has two numbers associated, an SKU number and a globally unique identifier. The system assigns a globally unique identifier to every item in the system. The a globally unique identifier is a long sequence of numbers and characters and is globally unique, no two items have the same number. SKU numbers are integral to how items are tracked in the system. The merchant has control over how the SKU numbers are created for an item, and the SKU number is derived in one of two ways.

The merchant has the option to assign its own SKU number, or they can let the system assign a SKU number. The system recommends, and preferably, the system will assign the SKU number. The system uses EAN 13 topology. With EAN 13, the number indicates the merchant, the category, and the identity of the item. A merchant will generally have its own five digit merchant number for EAN 13, and at its option, use that number. If it does not have a merchant number, a unique random number is generated. Every merchant has a merchant number assigned to it when a merchant registers an account on the system.

If the merchant decides to use its own numbering system, instead of EAN 13, the system uses code 128 topology. Either topology is used because the system provides bar code support, such as generating bar codes and making them available for printing by the merchant. Code 128 supports ASCII characters, which allows any kind of sentence or number. The system provides the bar code automatically when an item is entered into inventory, and automatically provides a SKU, unless the merchant opts to define its own SKU numbers.

When a new item is created and the merchant defines its own SKU numbers, the inventory item number is blank. If the system assigns the SKU number then every new item will have a unique SKU number that conforms to the EAN 13, and the item number is automatically displayed by the system.

Once an item is created, an inventory number is assigned. A description field is displayed, whereby any text description may be entered. Further optional information may be input, which may include the location of the item, such as showroom or retail store, or the age and material of the item. Further information may include date or origin; quantity in stock; the merchant's vendor; maker of the item; dimensions and weight; shipping options; pricing, such as percent to mark up or exact price; where to sell, such as in store, to dealers, on UTOPA.com, or on the merchant's website; costing method such as first-in-first-out (FIFO), or last-in-last-out (LIFO); and vendor internal code. The optional information may include the condition of the item such as mint, excellent, good, fair, or poor. The merchant can manage each list of options for each item.

The inventory feature of the system provides several functions to the merchant at the item input interface. The inventory system communicates with the purchase order system to provide an “allow auto order” function. For each item entered into the system, a purchase order is generated. The purchase order (PO) has a line item associated therewith representing the item. An item cannot be listed without a way to track it. When an item is initially entered, the quantity is zero by default, but can be specified by the merchant. The amount paid for the item by the merchant may also be specified.

The vendor of an item may be specified and by default, the system will specify “default vendor.” Merchants may sell their items without utilizing the PO system. Under the Maintain Purchase Orders utility, the merchant may modify the saved purchase order associated with an item. The utility displays and allows modification of the vendor; PO number; PO date; payment date; payment type, such as check, credit card, cash or other; amount of payment; notes; invoice number; invoice total; item name; item quantity; units; price per item; and total invoice price.

Every item entered into the system is attached to a vendor, and the system will automatically check for an open purchase order for the vendor that the item belongs to. If there is an open purchase order, the system will add the item to the open order. If there is no purchase order, the system will create one and add the item.

Knowledge of the date an item was ordered, how much was paid by the merchant, and the other information in the purchase order is critical to a business' financial information and for accurate reporting of metrics on items sold, cost of goods sold, and related information.

The system is also capable of assisting the merchant in supply chain management. When an item is purchased and the sale is approved, whether through the merchant's website, UTOPA.com or in the retail store's POS, the system will decrement the quantity of the item by the number of items transacted. If the quantity of an item is zero, the item will not be available for purchase. However, the merchant may enable the “allow auto order” function to allow the system to automatically order from the vendor when the quantity of an item reaches a threshold number specified by the merchant. The merchant does this by checking the “allow auto order” box. A purchase order is automatically generated by the system and the item is automatically added to the purchase order. The PO is sent to the vendor and additional items are ordered automatically. Items will continue to be available for purchase even if the quantity for the items are zero.

Many of the display boxes in the system are collapsible, so that a merchant can ignore a set of data and functions if it does not plan to use them. Also, for ease of use, the system can be set to remember the particular sets of boxes that are collapsed by clicking “save screen layout.”

After a merchant has selected the data to be input and functions used, the merchant may choose to receive expert analysis from the system by clicking “Expert Analysis.” When expert analysis is selected, the system analyzes all the input by the merchant into inventory and formulates advice based on proven sales methods. As shown in FIG. 5, a digital sales assistant (DSA), or virtual person, appears in a separate window and speaks this advice to the merchant. The DSA, while speaking makes facial expressions, such as eye blinking, head turning and tilting, cheek and mouth movement, all consistent with how an actual person would normally act. Advice pertains to increasing sales is generated in real time and will vary depending on what the merchant inputs into the system.

For example, the virtual person might say: “Hello merchant, and I have reviewed your settings and have a few suggestions. You have not included any additional information. Customers like to have as much information as possible in making a decision to purchase. Increase your chances of selling the item by including historical and factual information. You have not provided a picture. Studies have shown that when you include a high quality you greatly increase your chance of a sale. DSA was not enabled UTOPA has provided a digital sales assist technology to help you. Studies have shown that when you include a human face combined with speech greatly increase your chance of a sale.”

The inventory system has a module for providing the cost of shipping an item. As shown in FIG. 1, the merchant may input the height, width, and depth of any item, as well as the merchant's shipping address. When the customer provides the customer shipping address, the shipper will be queried to provide the cost of shipping to the system. A units converter is provided whereby a metric unit may be entered, and the system will return an English unit corresponding to the metric unit or vice versa.

The shipping options in the inventory system are customer pickup, delivery charge and may include United Parcel Service (UPS), United States Postal Service (USPS), Federal Express (FedEx), DHL or any shipping carrier that is integrated with the system. The merchant may select a delivery option and click “add shipping” and the selected delivery option will be available as an option to the customer when the customer chooses an item to purchase. For example, a merchant may offer its own a delivery service and may select “delivery charge” to be available for an item for sale. The merchant may specify an amount to charge for the selected delivery option, and the system will automatically add the specified charge to a customer's order.

When a merchant adds a shipping carrier as a delivery option for an item, the merchant may specify further delivery options offered only by the particular carrier selected. For example, if UPS is selected, the system may provide next day air, second day air, ground, worldwide express, and any service offered by the carrier. The merchant may select any combination for the system to make available to the customer at the point of sale. The options are provided to the merchant in a dropdown list and price is automatically displayed.

There are four different avenues through which a merchant can sell an item in the system. Those include sales through a retail store, sales to other dealers or merchants, sales on UTOPA.com and sales on the merchant's website. As shown in FIG. 2, the merchant may choose each option by clicking a checkbox. For each avenue, the merchant may specify a price for the item. An exact price may be specified or a percent mark up may be specified. The percent mark-up price is a percentage the merchant may specify that the system will use to provide a marked-up price. The marked up price is determined automatically by the system by calculating the percentage of a currant cost of an item and adding the cost to the current cost of the item. For example, the current cost of an item is one dollar and the merchant specifies a percent mark-up of 20%. The system will automatically calculate a price of one dollar twenty cents, and any time a user views the item marked-up, the system will display the marked-up price.

The current cost is determined from the purchase order system and may be input into the system in two places. When an item is entered by the merchant, the system creates the item and automatically creates a purchase order for the item. In the system, the item has an item header and item details. The item header contains envelope information about the item, such as the vendor, material, and shipping information. The line item details may include the current cost of the item and the location of the item. Every quantity associated with an item has a separate line item record, and is initially zero when the item is created. For every increment of quantity a separate detailed record created. For example, if an item is created and a quantity of five is specified, there are five detailed records. Every quantity has a cost amount associated. For example, if the merchant had specified a current cost of two dollars for the quantity of five in the above example, then each detailed record will have a current cost of two dollars associated. Subsequently, if the merchant clicks “add quantity” and adds ten to the quantity and specifies a cost of four dollars, then ten more detailed records are created, each having a current cost of four dollars associated.

Current cost is also determined by the specified costing method. The system includes first-in-first-out (FIFO) and last-in-last-out (LIFO) options that may be specified by the merchant. Under FIFO, the current cost is determined from current cost specified with the quantities entered into inventory with the oldest date. Under LIFO, the current cost is determined from the current cost specified with the quantities, which have been entered into inventory with the most recent date.

When the “allow auto order” function is selected and the item quantity is zero, the system will create a purchase order and create a line item in the purchase order. When the ordered items are delivered to the merchant by the vendor, the system posts the inventory and fulfills the order. If an item is purchased with a zero quantity, which is permissible if the merchant has clicked “allow auto order,” the system will record the number of oversold units. The newly delivered quantity will be added to the items inventory, less the number of oversold units. For example, if a quantity of six units of an item are oversold, and the merchant has ordered a quantity of ten units of the items from the vendor, the quantity listed in inventory is incremented by four units, only four units are posted to inventory.

As shown in FIG. 2, the purchase order system also provides a “view purchase order history” function that allows the merchant to view a purchase order history for an item. The history displays the date, inventory number, item description, vendor, quantity and cost for each purchase order of the item.

Each item may have as many as five images associated. The merchant may upload an image on to the system whereby the system will automatically resize the image, and adjust the image quality to achieve a maximum of about a three second load time for a customer to load an image of the item in the customer's web browser. A page that requires more than three seconds to load typically causes a potential customer to lose interest in the item. The system will automatically adjust the image to have about 500 pixels, while maintaining the aspect ratio, and maximizing the bit depth for the best resolution possible.

The system has about 5,000 categories from which to choose that the merchant may specify for an item. A specified category helps a customer locate an item on the website, or UTOPA.com. The customer may browse by category, or search within a category. The category is stored in the item header of the item.

The merchant may also display the (DSA) to a customer when viewing an item. The merchant may specify up to three lines of text for the DSA to communicate verbally to the customer when viewing the item. The DSA will appear with the item on UTOPA.com When the merchant clicks, “preview,” the system displays the DSA and accompanying monolog customers will see and hear, when they view the item. Studies have shown that when a human face speaks about an item to a customer, there is a greater chance of selling the item.

As shown in FIGS. 20 and 21, the POS has an employee management function. The system can track employee information such as time, hours worked, attendance, and schedules. The POS allows for “enforce scheduling”, which requires employees to be scheduled to work at the time the employee attempts to log in, in order to log into the POS. Under the function, “employee time and attendance”, the merchant may utilize a calendar to highlight a particular day, add an employee, specify a job type, and specify a start time and end time. Further employees may be added to the schedule. The employee function also includes an enforced time clock function, which, if enabled, requires an employee to clock-in, in order to log into the system, and records the clock-in and clock-out times of the employee.

Referring now to FIG. 22, under the payment types function, the merchant may set up a virtual terminal. In the virtual terminal, the merchant may specify the payment types accepted and those are available to both on-line sales and in the retail POS. For example, if a merchant accepts cash, Discovery, Pay-Pal and E-check, those payment options are available to customers on the merchants' website, UTOPA.com and the merchant's retail store. The merchant may further specify which payment types to allow for individual items. For example, the merchant may specify that for an antique chair, the merchant will accept only cash, while for a post card, the merchant will accept all forms of payment from the customer.

The system also includes a Multi-Dealer Mode function. For items sold in a mall, where there are multiple different dealers, the system can act as a single POS for all the dealers in the mall. Each item, when purchased, is applied to a specific dealer, and a report may be generated tracking the number of items sold from a given dealer in any one day. When an item is purchased in multi-dealer mode a sub-dealer identification number is captured by the system so that it can post the sale to the sub-dealer, and creates a line item for the dealer beneath the transaction header.

The system also includes an option to require customer information when accepting checks. If a customer elects to pay by check the customer's driver's license number, State and other identifying information may be required.

As shown in FIG. 23, the POS setup further includes a large receipt or small receipt option. If small receipt is selected, the system will generate receipts in a normal manner. The large receipt will generate receipts formatted for a laser or desk-jet printer, printing on 8.5 x 11 paper, for example. The receipt may or may not be printed with the company logo by clicking a box. Additionally, the system provides as options on the receipt, a header, footer and cardholder agreement.

Yet another option in the POS are loans and layaways. A “loan” is the lending of an item to a customer. In the business of antique dealing, dealers will allow customers to take an item to a location for preview. The system supports lending or loans. A merchant can specify the maximum length of the loan in days, can require the input of the customer information at check-out and can send an e-mail to the customer at a specified time before the loan expires, to remind the customer to return the item on time. When the item is on loan, the item is taken out of inventory and placed on hold. When the item is returned, the merchant clicks, “this item has been returned” and the item is placed back in inventory.

A transaction can also be specified as a layaway, whereby a customer may tender an amount less than the total price of the item to make the item only available for sale to a specific customer, and allow the customer to tender the remainder at a later time. The merchant may choose whether or not to require customer information at checkout. A percent of total is required at checkout and will serve as a deposit for the item transacted on layaway. For example, if 10% is required at checkout and the item's price is $100, the customer must pay $10. The maximum length of layaway is specified in days and this number is the number of days before payment of the remainder of the price is due, or else the item is taken off hold status and is placed available for sale to any customer. An item transacted on layaway remains in stock. The customer may make a payment on the item at subsequent times during the layaway period. The customer may come into the store and the cashier may bring up the transaction on a web browser and apply a method of payment. When the total price is reached, the system removes the item from hold and from inventory.

As shown in FIG. 24, the system includes a “Manage Users” function. The merchant may specify any number of users. Each sub-user can be assigned various access rights. A default user is always provided by the system and cannot be deleted. Each user is given a separate personal identification number (PIN), a completely numeric number, to access the POS System. Job types may be assigned to an individual employee, which may include sales manager, sales-person, clerk, or anything applicable the business of the merchant. Pay-rate for each job type may be specified as well as contact information and e-mail preferences. Each user may have specified security rights for each function in the system which include: Inventory, Purchase Orders, Vendors, Point of sale, Customers, Employee Schedules, Payment Types, Setup POS, View Internet Sales, Web Site, Manage Website, Account Settings, Account Setup, Billing History, Manage Users, Shipping Details, Dashboard, Pending Sales, Manage Inquires, Sales Metrics, Inventory Metrics, and Labor Metrics. Each user may be specified to have either no access, read only, or write access to each function.

All screens in the POS are designed for use by either a keyboard and mouse or by a touch-screen. The main point of sale screen provides information such as the software version, on-line status, location of register and/or register identification, transaction, date, time, and the user who is currently logged in.

When a merchant inputs the SKU of an item into the system, for example, with a bar code reader, the information is transmitted from the merchant's terminal to another computer in the system. The computer processes the information and returns item details, such as price and description, to the terminal. Once the item appears on the terminal, the merchant may perform various operations on the item. For example, the merchant may select the item, adjust the quantity, and delete the item. The merchant may select, “tender,” and add a credit card payment, a check payment, or a cash payment. In addition, the merchant may split the payment among various forms of payment. For example, for a single transaction the merchant may accept $5.00 in credit, $2.00 in cash and $10 in check, to complete the total sale.

As shown in FIG. 57, the system also includes a dashboard function. The dashboard provides metrics on inquires, sales, inventory, labor, web metrics and summaries of each, based on data from the merchant's website, UTOPA.com or the retail store POS. For each, the system provides analysis and presents each in two dimensional and three dimensional graphs. The system also includes a presentation by the DSA, in a newscast format. The DSA provides expert business analysis of the merchant's sales data, and explains the analysis in varying degrees of sophistication. For example, part of the analysis may be in terms a person with little education in economic theory may understand. The DSA provides an explanation of the results and significance of each result to the merchant's business. The DSA further provides an explanation of each graph and gives predictions about the merchant's business based on the merchant's business data. For example, the system provides best and worst performing items; recap sales by type, tenders, discounts, voids and labor costs; store performance reports, such as cash reconciliation for the period subtotaled by week; daily sales and sales mix reports; and profit and loss report showing sales expenses and profit by week and period.

The system further includes a website builder and manager. Referring to FIGS. 51-56, the website manager provides the merchant with options to display inventory on the merchant's website. For example, the system provides background color; font color; link color; font size; container height; font; border color; number of items to display; and container width; When the merchant specifies his desired options, he may click “generate code,” whereby the website builder will generate html code and instructions on where to paste the code. The system generates code pertaining to inventory, login page, shopping bag, and “my account.” The system also provides suggestions and templates for the merchant's website.

The inventory and point of sale system is completely based through the internet and is accessible through an ordinary web browser. The system is capable of handling a plurality of independent merchants, whereby each merchant may access the system through the internet with a web browser.

We claim:

1. A computerized management system, comprising:
an inventory system;
a point of sale system;
wherein the inventory system and point of sale system are integrated.
